(19) United States
(12) Patent Application Publication
(10) Pub. No.: US 2004/0136125 A1
(43) Pub. Date: Jul. 15, 2004

(54) Leakage current detection based upon load sharing conductors

(76) Inventors: David C. Nemir, El Paso, TX (US); Stanley S. Hirsh, El Paso, TX (US)

Correspondence Address: PEACOCK MYERS AND ADAMS P C, P O BOX 26927, ALBUQUERQUE, NM, 871256927

(21) Appl. No.: 10/430,488

(22) Filed: May 5, 2003

Related U.S. Application Data
(63) Continuation-in-part of application No. 09/394,982, filed on Sep. 13, 1999, now Pat. No. 6,560,079.
(60) Provisional application No. 60/100,577, filed on Sep. 16, 1998.
(60) Provisional application No. 60/394,103, filed on Jul. 6, 2002.
(60) Provisional application No. 60/434,332, filed on Dec. 17, 2002.

(51) Int. Cl. H02H 3/00

(52) U.S. Cl. 361/42

(57) ABSTRACT

An apparatus and method for detecting and interrupting electrical current leakages from the conductors in an electrical distribution system with a particular application to appliance power cords. Parallel conductive paths connect between the source and the load. Electrical current to one side of the load is furnished by these split paths with the other side of the load connecting to the source through a single conductive path. By sensing the imbalances in the split conductive paths, leakage currents that are undesirable and might lead to parallel arcing faults may be detected. By adding an additional sense line for the single conductor, complete series arc fault detection may also be accomplished. In some embodiments, two split conductors are used to supply power from source to load in one direction and two split conductors are use to supply power from source to load in a return direction. By sensing a change in the current division among these load sharing conductors, undesirable current leakages may be sensed. By adding a circuit breaker that activates in response to a sensed fault, complete series and parallel arc fault detection and interruption is accomplished.

### CROSS-REFERENCE TO RELATED APPLICATIONS

This application is a continuation-in-part of U.S. patent application Ser. No. 09/394,982, entitled “Ground Loss Detection for Electrical Appliances”, filed Sep. 13, 1999, which claimed the benefit of U.S. Provisional Patent Application Serial No. 60/100,577, entitled “Ground Loss Detection for Electrical Appliances”, filed Sep. 16, 1998, and the specifications thereof are incorporated herein by reference.

This application claims the benefit of the filing of U.S. Provisional Patent Application Serial No. 60/394,103, entitled “Leakage Current Detector Using Load Sharing Conductors”, filed on Jul. 6, 2002, and U.S. Provisional Patent Application Serial No. 60/434,332 entitled “Leakage Current Detection Based Upon Load Sharing Conductors”, filed on Dec. 17, 2002, and the specifications thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field):

This invention relates to an electronic circuit for the detection and interruption of electrical current leakage from the conductors in an electrical power delivery system, thereby allowing for the protection of personnel and property against the electrical shock and fire hazards that can accrue from said leakages.

2. Description of Related Art

A common source of electrical injuries in the home occurs when users place an AC operated electric appliance near a swimming pool, bathtub or sink basin. If water intrudes into the electrical appliance, it can serve as an undesirable leakage path for electrical currents. If these electrical currents pass through a human, the result can be injury or electrocution. Although water is often a contributor to dangerous electrical leakages, electrical leakage can also take place if a person touches an electrical conductor that is at one voltage potential, while, at the same time touching an electrical conductor of a significantly different voltage potential. When one of the voltage potentials is at a so-called “ground” potential, this leakage is called a ground fault. In the U.S., devices to detect and interrupt a ground fault are known as ground fault current interrupts or GFCIs. In Europe, this same class of devices is known as residual current devices or RCDs.

Ground faults are not the only class of potentially hazardous electrical leakage. Another type of undesirable operating condition occurs when there is a luminous discharge (a spark) between two conductors or from one conductor to ground. This spark represents an electrical discharge through the air or through aged or defective insulation and is objectionable because heat is produced as a byproduct of this unintentional “arcing” path. These arcing faults, or arc faults, are a leading cause of electrical fires. Arcing faults can occur in the same places that ground faults can occur—in fact, a ground fault would also be called an arcing fault if it resulted in a luminous discharge. As such, a device that protects against ground faults can also prevent some classes of arcing faults. A device that is specifically designed to detect and interrupt arc faults is called an arc fault current interrupt, or AFCI.

Although a GFCI is primarily directed at the protection of individuals against electrocution, an AFCI is targeted at preventing the higher current arcs that can lead to electrical fires. As such, GFCI circuits are typically set up to detect and interrupt a fault current on the order of 5 milliamperes or more, while an AFCI is designed to detect and interrupt fault currents on the order of 5 amperes or more.

A rule of thumb is that it requires a potential of 3000 volts per millimeter to establish an arc through the air. However, once established, an arc may be sustained by a much lower voltage because it passes through a heated plasma conductive path where there are many electrons available for conduction. Even at relatively low voltages, it is possible to generate an arc by separating two energized conductors. In an environment involving a high level of vibrations, there can be a repeated making and breaking of such contact and there can be a repeated establishment and extinguishment of an arc. This is known as a sputtering arc fault. Under these conditions, the heat of the arc can cause the ignition of combustible materials.

Arcing faults may be broadly categorized as either series or parallel arc faults. A series arc fault occurs when one of the current carrying paths which is in series with the load is unintentionally broken. For example, extreme flexing in an appliance power cord can cause one of the conductors to break and go into an open position when flexed, causing an arc as the current path is broken. A parallel arc fault occurs when two distinct conductors, having a different potential, are brought into close proximity or direct contact. In other words, a series arc fault occurs when two conductors that are supposed to be in contact (or shorted) are brought apart and a parallel arc fault occurs when two conductors that are supposed to be apart are brought together. Although an electrical arc is thought of as a light and heat producing event, it is possible to have low level, but undesirable, electrical leakages between conductors, that, if left unattended, can develop into higher current, high heat arcs. For the purposes of this application, these lower level leakages, that are precursors to arc faults, will also be classified as arc faults.

In the United States, ground fault current interrupters (GFCIs) are presently required by building codes to be installed in bathrooms and outdoor outlets in most new homes and commercial buildings. These devices detect a current imbalance between the amount of electrical current that is delivered from one of the two current delivery conductors and the amount that is returned on the other current delivery conductor. In a grounded system, the third conductor connecting source and load corresponds to an earth connection and in normal operation should not receive or deliver any electrical current. Any mismatch in the electrical currents coming from the two current delivery conductors signals that a potentially dangerous electrical leakage is taking place. In response to this condition, a GFCI triggers a relay or a circuit breaker that halts the delivery of electrical power, thereby preventing electrical injury.

In commercial GFCI circuits, the current carrying conductors that connect the AC source to the load will pass through a differential current transformer, thereby acting as primary windings for that transformer. The transformer has a secondary winding with many turns that go to an amplifier. In a two wire system, when no electrical leakage path to ground is present, all of the electrical current that goes out one wire returns in the other wire. Accordingly, the two currents, forward and reverse, balance out in terms of the magnetic flux that is generated in the current transformer and so no signal is generated in the transformer secondary. On the other hand, if there is leakage to ground at the load or from the conductors connecting the source to the load, then there will be an imbalance in the currents. In other words, more electrical current goes out one wire than returns in the other, the difference being the component of current that takes another path. This results in a net magnetic flux in the transformer and this will serve to generate an induced voltage in the secondary of the transformer. That secondary voltage is amplified and filtered and used to trip a relay or circuit breaker, thus removing power from the load and removing power from the leakage path.

Ground fault current interrupt devices that use a differential transformer to detect current imbalance are well known. U.S. Pat. No. 3,683,302 (Butler et al.) discloses a sensor for a ground fault interrupter that is operative to detect current imbalances by means of a differential transformer. U.S. Pat. No. 3,736,468 (Reeves et al.) discloses a GFCI that uses a differential sense transformer, the secondary of which is amplified to trip a circuit breaker. Other designs that combine a differential sense coil and amplifier combination to trip a circuit breaker upon ground fault detection include U.S. Pat. No. 3,852,642 (Engel et al.) and U.S. Pat. No. 6,381,113 B1 (Legatti). Ground fault current interrupters for particular use in cordsets are described in U.S. Pat. No. 4,216,516 (Howell) and U.S. Pat. No. 5,661,623 (McDonald et al).

In an electrical power system, there is a class of objectionable electrical leakage event that cannot be addressed by a conventional GFCI. This occurs when power carrying conductors become cut or frayed or the insulation ages, resulting in insulation breakdown. In such cases, a parallel arc fault can occur if the current flow is taking place from a hot (non-grounded) conductor to another hot conductor or from a hot conductor to a neutral (grounded) conductor. In addition to these potential parallel arc faults, a series arc fault can occur if any current carrying conductor is broken and a relatively high resistance path occurs between the two ends of this broken conductor as the electrical current flows between these two ends. A conventional GFCI cannot detect any of the above arc fault conditions.

One particular application in this regard is a window air conditioner unit. These units are commonly installed in a room window for summertime use and then are removed and stored in an attic for the winter. A room air conditioner is bulky and may have sharp edges. Some users will wrap the power cord around the air conditioner before putting it away for the winter. In the process of storing or removing the unit from storage, the power cord may be abraded or otherwise damaged. The power cord may be exposed to thermal cycling stresses. Over a period of years, the accumulated damage can compromise the safety of the cord and lead to leakages among the conductors in the power cord.

In order to address the deficiencies present in GFCI devices, a new class of device was developed specifically directed to the detection and interruption of arcing faults. U.S. Pat. Nos. 3,872,355 (Klein et al) and U.S. Pat. No. 4,903,162 (Kopelman) use heat sensing elements to detect the high heat conditions that are a byproduct of electrical arcs and then trip a circuit breaker. The problem with these approaches is that it is neither practical nor cost effective to locate a heat sensor in every location where an arcing fault is likely to arise. Furthermore, the time delay between the occurrence of an arc and its detection by a heat sensor may be considerable, ranging from seconds to minutes.

U.S. Pat. Nos. 4,848,054 and 5,510,946 (Franklin) and U.S. Pat. No. 6,388,849 B1 (Rae) disclose a protective circuit that trips a circuit breaker upon detection of an overload current condition which exceeds the maximum expected during normal transient conditions of operation, said overload condition said to be characteristic of an arcing fault. U.S. Pat. No. 5,224,006 (Mackenzie et al.) describes a system whereby the magnitude and rate of change of current is monitored. If the rate of change of current has a profile characteristic of a sputtering arc fault, a circuit breaker is tripped.

Additional arc fault detection circuits have been proposed that look for a specific signature characteristic of the current, voltage or electromagnetic field associated with arcing faults. Example devices include U.S. Pat. No. 4,639,817 (Cooper et al.), U.S. Pat. No. 5,047,724 (Boksinger et al.), U.S. Pat. No. 5,280,404 (Ragsdale), U.S. Pat. No. 5,185,684 (Beihoff et al.) and U.S. Pat. No. 6,407,893 B1 (Neiger). The filtering algorithms used by the above arc fault detection technologies require signal analysis over multiple cycles, thus allowing an arc to persist for some period of time. Furthermore, these technologies are relatively expensive and are better suited for implementation at a distribution panel where they can protect an entire branch within a residence or commercial building, rather than at a wall outlet or as part of an electrical cord.

A number of technologies have been proposed specifically for the protection against arc faults in an appliance cord. U.S. Pat. No. 3,493,815 (Hurtle) discloses a protective circuit in which each conductor of a two-conductor appliance cord is surrounded by insulation and then a conductive sheath which is electrically connected to the frame or housing of the load. The sheath is also connected to the gate electrode of a thyristor which is connected across the line. If the cord is cut, frayed or otherwise damaged, it said to result in an abnormal condition in which the high side of the line comes into contact with the sheath or with the housing of the load. If this occurs, the SCR will turn on, acting like a crowbar across the line and drawing enough power to trip a circuit breaker or blow a fuse. A problem with this approach is that the SCR may self destruct in an open state before tripping a circuit breaker, thereby rendering this protective method inoperative. Furthermore, since the appliance cord may be located a substantial distance from the associated electric circuit protective device, the impedance of the conductors may limit the flow of current to a value below that which would cause a circuit breaker to trip or a fuse to blow.

U.S. Pat. Nos. 3,769,549 (Bangert) and U.S. Pat. No. 6,292,337 B1 (Legatti et al.) disclose an appliance cord wherein each of the two power carrying conductors are surrounded by insulation and then by a conductive sheath which is connected to ground. In U.S. Pat. No. 3,769,549 (Bangert), the sheath also acts as a ground conductor and is electrically connected directly to the third “ground” prong of the plug. Any break or mechanical defect in the power conductors that might otherwise cause an undesirable electrical shock hazard is said to first cause an electrical leakage to either or both sheaths, thereby either creating a ground fault (Bangert) or creating a condition that is sensed as a ground fault (Legatti), and then tripping a relay or circuit breaker to remove power from the damaged cord. One problem with this approach is that the manufacture of the overall electrical cord is expensive as there are multiple layers within a cord. Each power carrying conductor is surrounded by insulation and then is covered with a conducting sheath. Then both of these double layered conductors are placed together and covered with still a third layer of insulation. The termination of the two sheaths to connections at either end of the power cord is mechanically difficult. This termination is particularly critical if the sheath is also intended for use as a ground conductor.

U.S. Pat. Nos. 4,931,894 (Legatti) and U.S. Pat. No. 5,642,248 (Campolo et al.) disclose a ground fault interrupt protected power cord in which both power conductors, plus an optional ground conductor, are enclosed in a single sheath which is electrically connected to one of the power conductors through a resistance. When electrical leakage to the sheath occurs, it generates an imbalance in the differential transformer of a ground fault detection circuit and trips an electrical breaker, removing power from the conductors. The addition of a braided sheath to conductors is an expensive process. Braids are not durable to mechanical cycling and flexure and must be of special construction. Furthermore, the cord construction will be necessarily thick and bulky since it consists of layers of conductor, insulator, conductor and insulator. A broken power wire within the cordset may only be sensed if it causes enough arc related heating to break down the insulation and cause electrical leakage to the sheath. The physical arrangement of the conductors in this design is critical. If, for example, rather than enclosing the conductors, the sheath was configured as a single wire, running parallel with the power wires, no protection would be afforded against an arc from one of the power conductors to the other power conductor or against a break in either the hot or the neutral conductor.

U.S. Pat. Nos. 5,943,198 and 5,973,896 (Hirsh et al.) disclose an electronic device for the detection of both ground faults and arcing faults from the conductors in appliance cords and electrical distribution systems. The designs work by using a conditioning module at the load side of the protected conductors that imposes dead zones at zero crossings of the AC line. During the dead zone interval, if electrical current flow is detected at the source side of the protected conductors, it is indicative of a leakage path around the load conditioning module and power is removed. The problem with this approach is its requirement for one or more load conditioning elements at the load side of the power cord.

Parent application U.S. patent application Ser. No. 09/394,982 (Hirsh et al.) discloses an electronic apparatus which may be built into an electrical appliance and that automatically checks for an open ground condition or the transposition of power conductors in the appliance. If either a ground connection is missing or the grounded and ungrounded power sources are swapped, then power to the appliance is automatically interrupted. This device can detect a broken or open neutral condition and a broken or open ground condition and can interrupt power in response thereto. In this way, the device may be considered to offer a degree of series arc fault protection. The key to the approach is to monitor the voltage potential difference between the grounded conductor (neutral) and ground. When this voltage potential exceeds a preset amount, it is indicative of a broken conductor and is used as a trigger to interrupt power to the appliance.

### BRIEF SUMMARY OF THE INVENTION

The present invention is of an apparatus (and corresponding method) for detection and interruption of electrical leakages in an electrical distribution system, comprising: multiple conductors wherein at least two of the multiple conductors serve as parallel paths for delivering power to an attached electrical load; a circuit breaker; means for detecting current imbalance between the parallel paths; and means for activating the circuit breaker in response to detection of the current imbalance between the parallel paths, thereby preventing power delivery to the attached electrical load. In the preferred embodiment, the parallel paths maintain substantially a same voltage potential and the parallel paths are connected together on one side of the attached load. If the electrical load is an electrical appliance (such as a room air conditioner), preferably a portion of the multiple conductors is secured within the electrical appliance to ensure a minimum level of resistance in each of the parallel paths. The circuit breaker, the means for detecting current imbalance and the means for activating the circuit breaker are preferably disposed within a plug receptacle, more preferably wherein the parallel paths are electrically connected together within the plug receptacle and wherein the invention further comprises means for detecting an imbalance in current flow coming from two power delivery prongs of the plug receptacle by use of a current sense transformer, and most preferably wherein the invention further comprises an electronic amplifier to trigger the circuit breaker in response to either a sensed current imbalance in the parallel paths or a sensed current imbalance from currents flowing in the power delivery prongs, the electronic amplifier containing a device selected from thyristors, transistors and operational amplifiers. The means for detecting current imbalance may comprise means for sensing a secondary voltage of a differential current transformer, in which case preferably the current imbalance is equivalent to an ampere turn imbalance in the differential current transformer. The means for detecting current imbalance may comprise means for comparing voltages across shunts that are in electrical series with the parallel paths, or means for sensing a change from a predetermined current division between the parallel paths.

The present invention is also of an apparatus (and corresponding method) for detection and interruption of electrical leakages, the apparatus comprising a power cord with three power carrying conductors connecting a plug receptacle to an appliance load, and further comprising: means for detecting an unbalanced current flowing within two of the three power carrying conductors; and means to interrupt current flow upon detection of the unbalanced current. In the preferred embodiment, the two of three power carrying conductors are electrically connected to each other at the plug receptacle, thereby forcing them to maintain a substantially equivalent voltage potential, preferably wherein the appliance load is divided into two parts, each of which is connected to one of the two of three power carrying conductors, which embodiment is especially useful if the appliance load is an electric iron or an electric heater. The means to detect an unbalanced current flow preferably comprises a current sense transformer or means for comparing voltages across current shunts. A fourth conductor may be employed for attachment to earth ground and which does not normally carry power, in which case the invention preferably further comprises means for ground fault detection and interruption, most preferably wherein when a voltage between the third of the three power carrying conductors and the fourth conductor exceeds a threshold amount, it results in current flow in the fourth conductor, thereby activating ground fault detection and interruption and thereby preventing series arcing in the third conductor due to a break in the third conductor. Within the plug receptacle the two of the three power carrying conductors preferably pass through a current sense transformer in opposite directions and then are electrically connected to a plug prongs that attaches to the plug receptacle.

The invention is additionally of an apparatus (and corresponding method) for detection and interruption of electrical leakages comprising a power cord with four distinct conductors connecting a plug receptacle to an appliance load (such as a room air conditioner), and wherein: first and second of the four conductors have a same voltage potential and serve to carry substantially all power from the plug receptacle to the appliance load in one direction; third and fourth of the four conductors have a same voltage potential and carry substantially all power from the plug receptacle to the appliance load in a return direction; and additionally comprising means for detecting an electrical current imbalance in the first and second conductors and for tripping a circuit breaker in response thereto. In the preferred embodiment, the means for detecting an electrical current imbalance comprises means for detecting a change from a predetermined current division between the first and second conductors. The invention may additionally comprise means for detecting an electrical current imbalance in the third and fourth conductors and means for tripping a circuit breaker in response thereto, in which case the means for detecting an electrical current imbalance preferably comprises means for detecting a change from a predetermined current division between the third and fourth conductors. The third conductor may carry substantially all power from the plug receptacle to the appliance load in an opposite direction from the first and second conductors and the fourth conductor serves as a means for sensing damage in the third conductor, in which case the damage is sensed upon presence of a voltage potential on the fourth conductor that is different from a voltage potential of the third conductor by a value that is in excess of a predetermined voltage potential, and wherein a circuit breaker is activated in response thereto, thereby serving to interrupt power delivery in case of a break in the third conductor and thereby preventing occurrence of a series arc fault in the third conductor, preferably wherein the predetermined amount of voltage potential is electronically monitored using one or more devices selected from diodes, zener diodes and bilateral trigger diodes. A fifth conductor may be employed for attachment to earth ground and which does not normally carry power.

The present invention performs the detection and interruption of an undesirable electrical leakage in electrical conductors. It is specifically targeted at preventing arcing faults within an electrical appliance cord or an electrical extension cord by means of detecting the current imbalance in two parallel load sharing conductors. By taking a single power conductor and splitting it into two separate parts, the current delivery to an appliance is split into two proportional components. If the appliance cord is damaged in such a way as to cause a leakage to or from one of these two parts, then the electrical current flow in those two split conductors is no longer proportionally divided between the two conductors. This is detected and the information is used to trip a circuit breaker, thereby removing power from the power cord and, consequently, from any load to which it is attached. When used with a ground fault interrupt circuit, protection is provided for the following fault conditions in a power cord: ungrounded conductor (hot) to ground, hot conductor to grounded conductor (neutral), hot conductor to hot conductor, neutral conductor to ground, and broken wire detection/interruption (series arc fault). A GFCI circuit alone only protects against two of the above five fault conditions, namely, the two faults to ground.

Prior art approaches to arc fault detection/prevention in an electric power cord are expensive and/or slow to respond and/or nonresponsive to certain classes of arcing fault. When they use an analysis of the electromagnetic signature as the means of arc detection, they require multiple cycles of the AC line for detection, so they are slow to respond. When they use special sheathing on the power conductors, this requires an expensive manufacturing process and results in a mechanically unwieldy cord. When the sheathing is not made over individual conductors but over all conductors, this may not allow the detection of leakages between conductors that are inside the sheath. Accordingly, the present invention has the following objects and advantages when applied to an appliance cord, an extension cord, or the power conductors in an electrical distribution system:

a. It detects an electrical current leakage from any ungrounded conductor to ground, both within the cord and downstream at the load and interrupts the power flow upon said detection;

b. It detects an electrical current leakage from any ungrounded conductor to any grounded conductor and interrupts power flow upon said detection;

c. It detects an electrical current leakage from any ungrounded conductor to any ungrounded conductor within a power cord and interrupts power flow upon said detection;

d. It detects a broken conductor and interrupts current flow before this so-called “series arc fault” can cause a high heat condition;

e. It is inexpensive to build, with some embodiments requiring little more than a conventional GFCI circuit combined with a multiwire power cord.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a block diagram of prior art GFCI circuit;

FIG. 2 is a block diagram of the split conductor embodiment of the present invention for detecting a current leakage;

FIG. 3 is a circuit schematic of the split conductor system with differential sense transformer;

FIG. 4 is a circuit schematic corresponding to a fault condition;

FIG. 5 illustrates a split load configuration for a load that may be divided into two parts;

FIG. 6 illustrates a specific embodiment of a current leakage sensing system according to the invention;

FIG. 7 illustrates a specific embodiment of a current leakage detection/protection system without using a differential sense transformer;

FIG. 8 illustrates a specific embodiment for complete parallel and series arc fault detection using two sets of two split conductors;

FIG. 9 illustrates the combination of arc fault protection with ground fault protection according to the invention;

FIG. 10 illustrates arc fault protection combined with ground fault protection using a single sense transformer and as implemented in an electrical distribution system;

FIG. 11 illustrates a specific embodiment for full series and parallel arc fault protection;

FIG. 12 illustrates construction for one possible power cord according to the invention;

FIG. 13 illustrates full power cord current leakage detection using a single current sense transformer;

FIG. 14 illustrates a tuning circuit for trimming a leakage detection circuit;

FIG. 15 illustrates a specific embodiment of cordset fault protection in an electric iron; and

FIG. 16 illustrates a specific embodiment as applied to a room air conditioner.

### LIST OF REFERENCE NUMERALS

20—Prongs

21—Plug or plug receptacle

22—Power conductor

24—Power conductor

26—Current sense transformer

27—Power conductor in power cord

28—Secondary winding of current sense transformer

29—Power conductor in power cord

30—Detection electronics and circuit breaker trigger

32—Circuit breaker contact

33—Circuit breaker contact

34—Load

36—Solenoid

38—Electrical leakage path from power conductor to ground

39—Earth ground

40—Electrical leakage path from load to ground

42—Circuit breaker trigger thyristor

44—Power cord connecting plug to appliance

46—Electrical appliance

50—Manual test button

52—Fault test resistor

54—Parallel arc fault between power conductors

56—Possible break between points A and B where a series arc fault can occur

58—Electrical leakage path from power conductor to ground

60—Power conductor attached to plug prong

61—Unsplit power conductor

62—Power conductor attached to plug prong

63—Lumped resistance

64—First parallel (split) power conductor

66—Second parallel (split) power conductor

68—Series resistance in the plug

70—Series resistance in the plug

72—Split load resistor

74—Split load resistor

76—Series resistance in the appliance

78—Series resistance in the appliance

79—Load current

80—Parallel arc fault

84—Differential transformer for detecting arc fault

86—Lumped resistance for conductor within power cord

88—Lumped resistance for conductor within power cord

90—Secondary of transformer for detecting arc faults

94—Source voltage

96—Trigger resistor

98—Filter capacitor

100—Shunt resistor

102—Shunt resistor

103—Ground wire

104—Point A

105—Ground prong

106—Point B

107—Current limiting resistor

108—Difference amplifier

109—Back to back zener diodes

110—First split conductor from conductor 60

111—Point D

112—Second split conductor from conductor 60

113—Voltage divider resistor

114—First split conductor from conductor 62

115—Bilateral trigger diode (diac)

116—Second split conductor from conductor 62

117—Voltage divider resistor

118—Current sense transformer for detecting both ground and arc faults

119—Return conductor from appliance

120—Power outlet

122—Female receptacle

123—Conductor connecting to ground prong

124—Ground conductor

125—Voltage divider

126—Ground prong on plug

128—Unexposed area of power cord

134—Five conductor flat power cord

135—Power source into plug

136—Load center

137—Branch wiring

138—Power source into plug

138—Power input

140—Low resistance conductor

142—High resistance conductor

144—Low resistance conductor

146—High resistance conductor

148—Limit resistor

150—Limit resistor

152—Adjustment resistor

154—Primary windings of conductor 142

156—Secondary winding on differential sense transformer

160—Lumped wire resistance

162—Lumped wire resistance

164—Lumped wire resistance

166—Lumped wire resistance

168—MOSFET

170—Sense amplifier

172—Capacitor

174—Synchronizer

176—Charging resistor

178—Charge storage capacitor

180—Window comparator

182—Steering diodes

184—Limiting resistor

188—Return from neutral

190—Amplifier for ground fault

192—Difference amplifier

194—Electric iron

196—Controller

198—Load element

200—Load element

202—Wire cross section

204—Grommet

206—Terminal block

208—Air conditioner housing

210—Air conditioner electrical load

212—Spade lugs

### DETAILED DESCRIPTION OF THE INVENTION

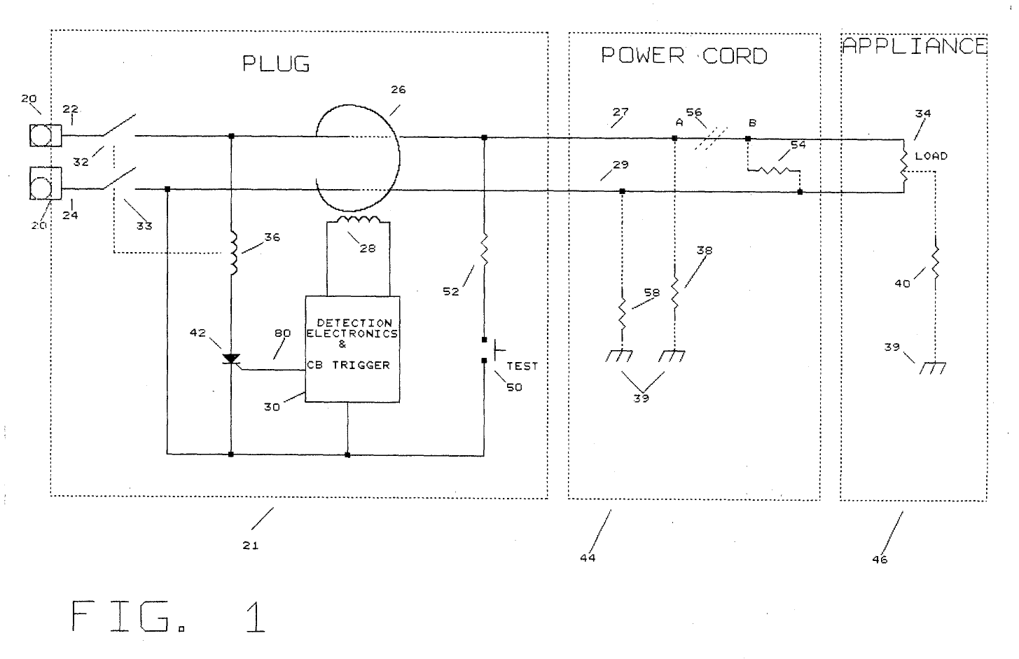

FIG. 1 presents a block diagram that functionally describes the majority of present day GFCI circuits as implemented in either an appliance cord or an extension cord. The GFCI detection and interruption circuitry is completely disposed within a plug 21. A power cord 44 connects between the plug 21 and an electrical appliance 46. The plug (or plug receptacle) 21 is a housing that contains conductive prongs 20 and that contains internal fault sense and interrupt electronics and that connects to the power cord 44. Power is applied to the system through the plug prongs 20 which receive power from an electrical outlet. The source conductors are 22 and 24. In the U.S., the outlet position into which one of these conductors is connected may be required by code to be grounded at a distribution panel and the corresponding conductor is known as the neutral conductor. In such a system, the ungrounded current carrying conductor would be called the hot conductor. Conductors 22 and 24 are connected to conductors 27 and 29 through circuit breaker contacts 32,33. Conductors 27 and 29 pass through a differential current sense transformer 26 and thereby act as the primary for that transformer. It should be noted that conductors 27 and 29 pass through transformer 26 in the same direction. The secondary 28 of current sense transformer 26 connects to the detection electronics and circuit breaker trigger 30, which may filter and/or amplify and/or otherwise process the voltage from the secondary windings 28 of the current sense transformer 26, to produce a trigger signal to open the circuit breaker contacts 32,33. Circuits that implement the function of block 30, interfacing with a differential sense transformer and producing a trigger signal are well known in the literature and in practice (see, for example, U.S. Pat. No. 5,224,007, to Gill).

In normal operation, electrical current is delivered to the load 34 via normally closed circuit breaker contacts 32,33. The load 34 is an impedance that may be resistive, inductive or capacitive or some combination thereof. Although FIG. 1 depicts a load directly attached to the end of the power cord, FIG. 1 could equally well depict an extension cord whereby load 34 would actually represent one or more female outlets into which various appliances could be attached.

In the absence of a ground fault, the same amount of current flows in conductors 27 and 29, but in opposite directions. The net magnetic flux in the differential current sense transformer 26 is zero and the voltage that is generated in the transformer secondary 28 is zero. When an electrical leakage path 38 occurs from conductor 27 to ground 39, or an electrical leakage path 58 occurs between conductor 29 and ground 39, or an electrical leakage path 40 occurs from within the load 34 to ground 39, then there is a current imbalance between conductors 27 and 29. That is, there is a different amount of current flowing in conductor 27 than in conductor 29 as the two conductors pass through the differential sense transformer 26. This leads to a net magnetic flux that is induced in the differential sense transformer 26, resulting in a nonzero voltage being generated in the secondary 28. The detection electronics 30 then takes in this voltage signal and processes it to determine whether a current imbalance (corresponding to a fault) of sufficient magnitude and/or duration has occurred. If the detection electronics 30 determines that the fault is of sufficient magnitude and/or duration, then it triggers a thyristor 42 into conduction which causes current to flow through the solenoid 36, thereby opening the circuit breaker contacts 32,33 and removing power from the appliance power cord 44 and the appliance 46.

In a grounded neutral system, one of the two conductors 22 or 24 will be very close to a ground potential. Consequently, the occurrence of a leakage path from this neutral conductor to ground may not result in an appreciable flow of electrical current and the event might go undetected by the detection electronics and circuit breaker trigger 30. For this reason, some embodiments of GFCIs incorporate a second differential sense transformer, not shown in FIG. 1, to detect for the presence of these so-called “neutral to ground faults”. This is done by injecting a signal into the neutral conductor which produces an oscillation if feedback is provided through the loop completed by the neutral to ground fault. This feedback then serves to cause an amplifier within the GFCI to recognize a fault condition. This neutral to ground protection is often used in outlet GFCIs because it protects against the occurrence of a grounded neutral on the load side of the GFCI circuit breaker. Since the neutral to ground potential is seldom greater than 1 volt, a neutral to ground fault will seldom present either a shock or a fire hazard.

Test button 50 allows a manual test of the proper operation of the fault sensing/interrupting circuitry. This button is normally open. When test button 50 is engaged, it implements an electrical leakage path that goes around the differential current sense transformer 26 and thereby simulating a fault condition. The amount of electrical leakage is determined by the resistance value of the fault test resistor 52. This deliberately applied electrical leakage causes a current imbalance that is sensed by the detection electronics 30 and then triggers the thyristor 42 which energizes the solenoid 36, thereby causing the circuit breaker contacts 32,33 to be opened. A user can thus manually test the GFCI by engaging the test button 50 and listening for the relay contacts 32,33 to open and/or observing a visual indicator (for example, in many implementations, a reset button will pop up).

There are two types of electrical fault that the circuit in FIG. 1 cannot detect. First, it cannot detect a parallel arc fault 54 between the power conductors 27,29 in the cord. The reason is that from the plug 21 this parallel arc fault 54 appears to be a load that is in parallel with the legitimate load 34. No current imbalance is created in the differential transformer 26, and so no fault is recognized. The second class of objectionable fault that will go undetected by the circuit in FIG. 1, is if a break occurs in a power conductor, such as a break 56 between points A and B in FIG. 1. This corresponds to a series arc fault. This series arc fault event will go undetected by the electronics in the plug 21 because it will not result in a current imbalance in the differential transformer 26.

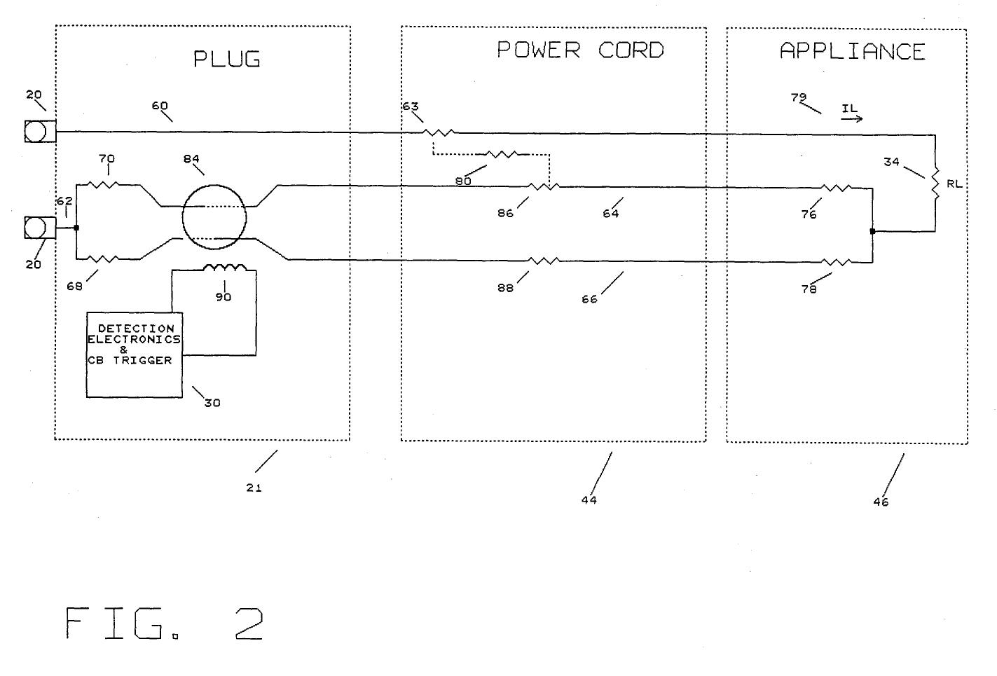

FIG. 2 depicts the physical arrangement of conductors that enables the arc fault detection ability of the present invention. As before, the system consists of a plug 21, an electric appliance 46 and a power cord 44 connecting the plug 21 to the appliance 46. Attached to the prongs 20 of the plug 21 are conductors 60 and 62. Conductor 60 connects directly from the plug prong to the load 34 which is resident within the appliance 46. Conductor 60 has a distributed resistance which, for convenience, is represented as a lumped resistance 63. If, for example, power conductor 60 is a 16 gauge wire then the distributed resistance is approximately 4 milliohms per foot, so if power conductor 60 is six feet long, then resistance 63 would be approximately 24 milliohms. Conductor 62 is split into two parallel power conductors 64 and 66. Each of conductors 64 and 66 has resistance associated with it. This resistance is due to the nonzero distributed resistance that all wires have, plus any contact resistances associated with making mechanical connection of conductors to lugs, circuit boards or other conductors.

In FIG. 2, the resistance in conductor 66 is depicted as having three parts. The portion of the resistance that is resident in the plug 21 is denoted by 68. This might reflect wire resistance within the plug, contact resistance due to crimped, soldered or welded connections, or a deliberately variable resistance that is designed for adjustment at the time of manufacture. The portion of the resistance that is contributed by the power cord 44 is denoted by 88 and denotes the resistance that is in the wire connecting the plug 21 and the appliance 46. The portion of the resistance that is contributed by the appliance is denoted by 78, and might reflect wire resistance within the appliance, contact resistance due to crimped, soldered or welded connections, or an additional resistance that is deliberately added. In a similar way, conductor 64 has a resistance that may be divided into three parts 70,86,76.

Conductors 64 and 66 are connected together at conductor 62, then pass through a differential transformer 84 and are reconnected together again within the appliance 46. Although conductors 64 and 66 carry parallel currents, they pass through the differential transformer 84 with opposite orientations. This is done so that the magnetic flux induced in transformer 84 by current in conductor 64 will be in an opposite direction from the magnetic flux induced in transformer 84 by current in conductor 66. Although in FIG. 2, the conductors 64 and 66 are depicted as passing through differential transformer 84 a single time, they may be looped multiple times to increase sensitivity. The differential transformer 84 serves as a sensing means to detect an imbalance in the electrical current flow in conductors 64 and 66. Ensuring that a significant portion of the resistance in each of the two split conductors is resident in the appliance will be important to the correct function of this circuit. As will be seen in reference to subsequent figures, resistances 76, 78 are important to the operation of the invention and can be ensured by securing a portion of the overall electrical cord length within the appliance 46. For example, if the design is constructed using a ten foot long electrical cord, nine feet of this electrical cord can connect between the plug 21 and the appliance 46, with the remaining 1 foot of electrical cord secured within the appliance 46. In this case, the resistance 78 would have a value that is at least 10% of the resistance 88 in the line cord.

Although all of the resistances in FIG. 2 are depicted as being “lumped”, that is, located at specific points, in fact, they may be distributed. Furthermore, although all of the ensuing discussion refers to resistance, the total “impedance” to the flow of electrical current may include frequency dependent components such as inductance and capacitance. For the purposes of the circuit analysis necessary for describing the present invention, the use of lumped resistances will suffice, although it will be apparent to one skilled in the art that a more complicated model could be used.

In normal operation, the load current is I_{L} 79 and this current enters the load 34 from conductor 60, passes through the load 34 and then is split into two equal currents, one part going through conductor 64 and the other part going through conductor 66. This division into equal parts assumes that (a) the total series resistance in conductor 64, which consists of the sum of resistances 70, 86 and 76, equals the total series resistance in conductor 66, consisting of the sum of resistances 68, 88 and 78; and (b) the same number of turns are made of conductors 64 and 66 around current sense transformer 84, but in opposite directions. The two equal currents balance each other out and there is no net flux in the differential transformer 84 and no voltage developed across the secondary 90 of the current sense transformer 84. However, if a parallel arc fault 80 occurs between conductor 60 and one of the two split conductors (in this case, conductor 64), then this will result in a current leakage path around the load 34 and, as it passes through the sense transformer 84, more current will flow in conductor 64 than in conductor 66. This will result in a flux imbalance in differential transformer 84 and will serve to generate a voltage in the transformer secondary 90 which can be used to trigger a circuit breaker (not shown), removing power from the system.

In FIG. 2, a parallel arc fault 80 can occur anywhere within the distributed line resistances. This is depicted by showing fault 80 as connecting between resistances 63 and 86. The fault occurs in such a way as to split the distributed line resistance in each line into two parts, depending upon where the fault occurs in the conductors 60 and 64.

In FIG. 2, the two split conductors 64 and 66 are depicted as passing through differential transformer 84 one time with each having different orientations. The number of turns is somewhat arbitrary. Both conductors 64 and 66 could equivalently be configured with two windings or any arbitrary number of windings. In some implementations, it might be desirable to use conductors 64 and 66 that are not balanced in total resistance. In this case, a balanced system (that is, in the absence of a fault, there is zero voltage at the transformer secondary 90) can be achieved if the total resistance in one split conductor is N times the total resistance in the other split conductor, so long as the conductor with higher resistance is wound N times as many turns around differential sense transformer 84 relative to the number of turns of the lower resistance split conductor. In the absence of a fault, the key requirement for a balanced system is that the ampere turns (that is, the product of electrical current times the number of turns) in the differential transformer 84 that are due to one of the split conductors (either 64 or 66) is exactly offset by the ampere turns due to the other split conductor.

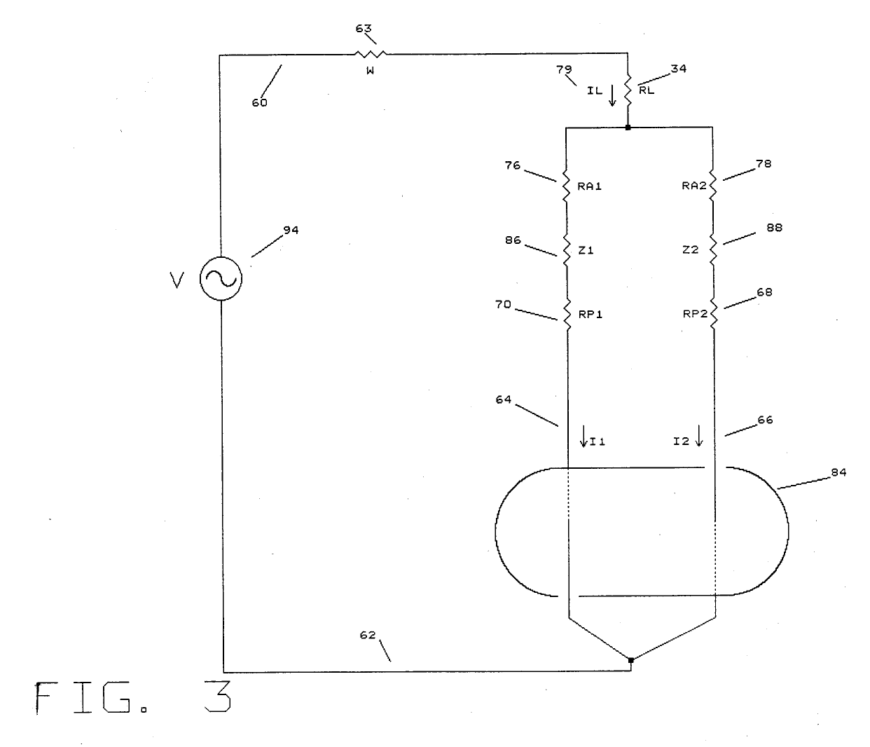

FIG. 3 depicts the electrical representation of the system of FIG. 2 when no fault is present. A source voltage 94 is applied across conductors 60 and 62. Conductor 62 is split into conductors 64 and 66 and then these two conductors pass through a sense transformer 84 in opposite directions. As in FIG. 2, the resistances in conductor 64 are divided into three parts. R_{P1} 70 represents the portion of the series resistance that is resident in the plug. Z₁ 86 represents the portion of the series resistance that is in the power cord, and R_{A1} 76 represents the portion of the series resistance that is resident in the appliance, prior to conductors 64 and 66 coming together in an electrical connection. In a similar way, the resistance in conductor 66 may be partitioned into three parts, R_{P2}, Z₂ and R_{A2}.

Electrical current I_{L} 79 passes through the conductor resistance W 63, then through load 34 and then into the two parallel conductors 64 and 66. Conductors 64 and 66 pass through the differential current transformer 84 (note that they pass through in opposite directions from one another). Current divides in conductors 64 and 66 according to the well known current divider law:

$${I}_{1} = {I}_{L} * \frac{{R}_{A2} + {Z}_{2} + {R}_{P2}}{{R}_{A1} + {R}_{A2} + {Z}_{1} + {Z}_{2} + {R}_{P1} + {R}_{P2}} , \\ {I}_{2} = {I}_{L} * \frac{{R}_{A1} + {Z}_{1} + {R}_{P1}}{{R}_{A1} + {R}_{A2} + {Z}_{1} + {Z}_{2} + {R}_{P1} + {R}_{P2}} \qquad ( 1 )$$

Although FIG. 3 depicts the conductors 64, 66 as passing through the differential current transformer 84 one time, conductor 64 may be looped any number N₁ turns around the transformer 84, and in the same way, conductor 66 may be looped any number N₂ turns around the transformer 84 in an opposite direction to the turns of conductor 64. The net flux developed in the transformer 84 will be zero as long as the ampere-turn contributions from each of the two split conductors are the same, that is, as long as N₂I₂=N₁I₁. Using equation (1), this condition is true if

N₂(R_{A1}+Z₁+R_{P1})=NI(R_{A2}+Z₂+R_{P2}), (2)

and is independent of the value of the load resistance R_{L} 34. Equation (2) is always satisfied if N₁=N₂, R_{A1}=R_{A2}, Z₁=Z₂, and R_{P1}=R_{P2}, however, this is not the only combination that will satisfy equation (2). In a production setting, it may be useful to built a cordset first, attach it to the appliance and then to adjust any arbitrary element of equation (2) in order to establish the equality.

In building the split conductor design, it will be difficult to ensure that the condition in equation (2) remains satisfied over time. Power conductors will age and may acquire oxidation that will impact the resistance. Individual wire strands within the conductor may be stretched or broken and this can affect the balance. However, while the resistances in the two legs cannot be matched exactly, there are construction steps that can be taken to enhance the robustness of the design to mismatches in resistance. Resistances R_{A1} and R_{A2} are captive within the appliance and will not be exposed and will therefore be less vulnerable to external damage. In a similar way, resistances R_{P1} and R_{P2} will be captive within the plug assembly. Accordingly, the primary concern during use in the field is changes to Z₁ and Z₂. Such changes are somewhat mitigated if the power cord is constructed so that the conductors are physically maintained in the same relative topology (e.g., using a flat style of power cord such as the so-called SPT type cord). In that case, external influences on one split conductor are likely to impact the other split conductor in a similar manner.

As part of the initial construction, by increasing the sum R_{A1}+R_{P1}, (equivalently, R_{A2}+R_{P2}), the influence of changes in Z₁ (equivalently, Z₂) on the total conductor resistance is diminished. Accordingly, resistances R_{A1}, R_{A2}, R_{P1} and R_{P2} serve as desensitization elements. Any increase in these resistances, subject to satisfying equation (2), will serve to desensitize the circuit balance to changes that may occur in Z₁ and Z₂ over time.

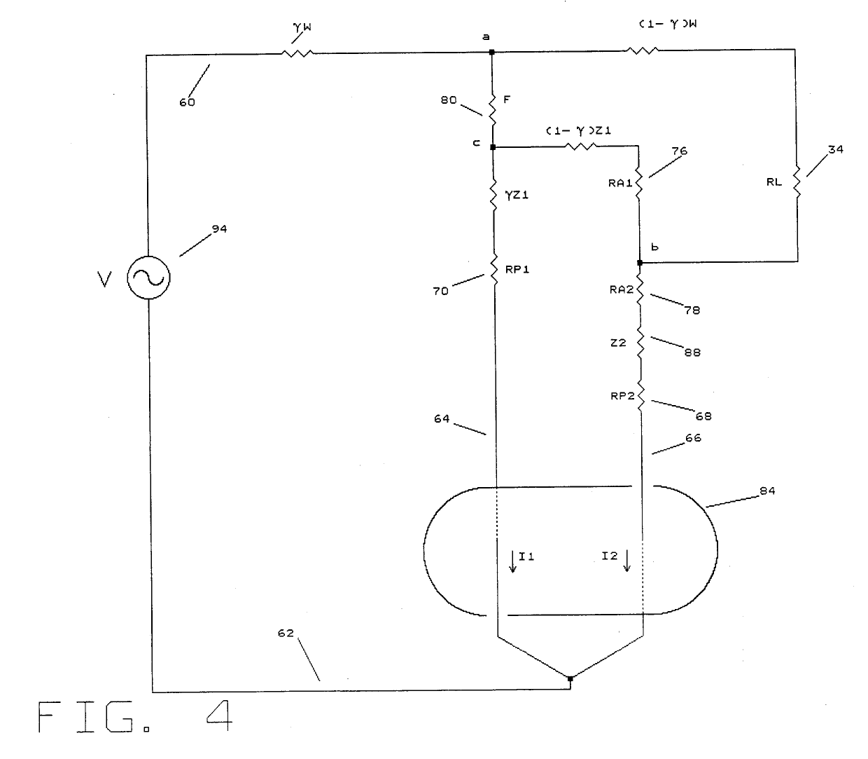

FIG. 4 depicts the event of a parallel arc fault occurring in the power cord between conductor 60 and conductor 64. Referring back to FIG. 2, the fault 80 splits the distributed resistances 63 and 86 into respectively, one portion that is on the load side of the fault 80 and one portion that is on the source side of the fault 80. In FIG. 4, the fault 80 is assumed to occur some per unit distance of γ along the cord length. That is, if the fault occurs at the entry point of the power cord into the appliance, then γ=1 and if the fault occurs at the exit point of the power cord from the plug, then γ=0.

By applying a well-known delta to Y conversion between nodes a, b and c, it is possible to get an expression for various currents in the circuit. The total current coming out of the source 94 is seen to be

$$I = \frac{V}{Rs + \frac{{R}_{1} * {R}_{2}}{{R}_{1} + {R}_{2}}} \\ where \\ {R}_{1} = \frac{F [ ( 1 - γ ) {Z}_{1} + {R}_{A1} ]}{F + {R}_{L} + ( 1 - γ ) {Z}_{1}} + γ {Z}_{1} + {R}_{P1} , \\ {R}_{2} = \frac{{R}_{L1} [ ( 1 - γ ) {Z}_{1} + {R}_{A1} ]}{F + {R}_{L} + ( 1 - γ ) {Z}_{1}} + {R}_{A2} + {Z}_{2} + {R}_{P2} \\ and \\ Rs = \frac{F * {R}_{L}}{F + {R}_{L} + ( 1 - γ ) {Z}_{1}} . \\ \qquad ( 3 )$$

Using the current divider law, an expression for the change in ampere turns (the so-called differential ampere turns) at the sense transformer 84 may be derived:

$$Δ N I = {N}_{1} {I}_{1} - {N}_{2} {I}_{2} = \frac{V {N}_{1} {R}_{2} - V {N}_{2} {R}_{1}}{Rs ( {R}_{1} + {R}_{2} ) + {R}_{1} {R}_{2}} . \qquad ( 4 )$$

where N₁ is the number of primary windings of conductor 64 that are made around sense transformer 84 and N₂ is the number of primary windings of conductor 66 around sense transformer 84. The magnetic flux that is generated within transformer 84 is proportional to ΔNI. Through magnetic coupling to the secondary of transformer 84 (the secondary is not shown in FIG. 4), the term ΔNI generates a voltage and current that are processed to detect a fault condition.

From equation (4) it is easily seen that the differential ampere turns that will be sensed in the current sense transformer 84 is a complicated function of the system parameters. ΔNI is a function of eleven variables, namely, R_{A1}, R_{A2}, R_{P1•}, R_{P2}, Z₁,_{y}Z₂, N₁, N₂, R_{L}, F, and γ. By making simulation studies on different operating conditions using typical values of the various parameters, it is possible to make a few general statements. First, the closer that a fault occurs to the plug, the higher the imbalance in the split conductors. This is a reasonable result because the resistance between the fault location and the source decreases on the faulted conductor, favoring current flow to the source along that path. Second, the percent current imbalance is a function of the fault severity. Low resistance faults are more severe and will result in more current flow from the source and more current imbalance in the split conductors. Third, the resistances R_{A1} and R_{A2} are important in allowing the recognition of a fault.

From inspection of FIG. 4, some general comments on the role of the appliance series resistances 76 and 78 may be made. First, if these resistances are zero and γ=1, it is impossible to distinguish a fault 80 from a legitimate load 34. In other words, it is imperative to have nonzero appliance series resistances R_{A1} and R_{A2} (76 and 78). Second, if the magnitudes of R_{A1} and R_{A2} are large relative to the magnitudes of Z₁, Z₂, R_{P1} and R_{P2}, then a fault F 80 will have a greater influence on the imbalance current ΔI and will be more easily detected. Accordingly, increasing R_{A1} and R_{A2} has the effect of sensitizing the system to a parallel arc fault 80.

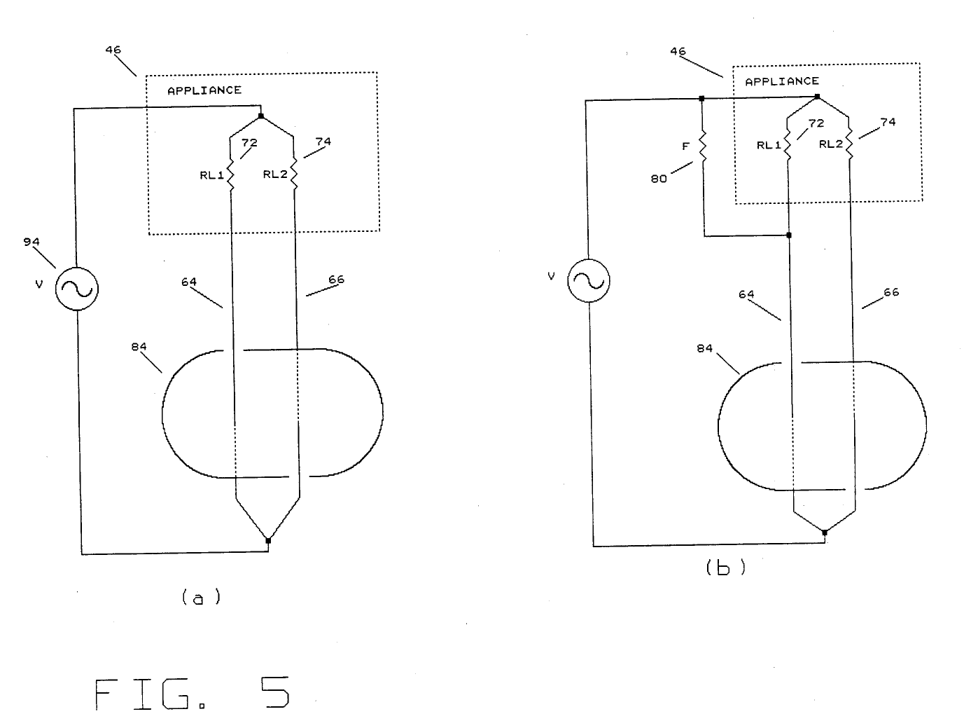

Some appliances, for example, appliances whose load primarily consists of resistive heaters such as electric irons, heaters and hair dryers, could be easily built to exploit the fault detecting features of the split conductor approach of the present invention. This is because a heater load may be easily subdivided. For example, by splitting the load resistance 34 into two parts, each of which connects to one of the two split conductors, the sensitivity to a fault 80 may be increased while simultaneously desensitizing the system to a current imbalance that occurs due to the aging of the conductors connecting plug to appliance. This system is depicted in FIG. 5, where the load is represented as parallel resistances R_{L1} 72 and R_{L2} 74. Since these load resistances are much larger than the distributed resistances within the conductors that attach the plug to the appliance 46, then, without loss of generality, the system may be simplified to consideration of only the load resistances R_{L1} 72 and R_{L2} 74.

Accordingly, when a fault occurs, as depicted in FIG. 5(b), the resistance of one of the split conductors is unchanged, while the path consisting of the second split conductor in parallel with fault resistance 80 has a reduced resistance. The amount of imbalance in the ampere turns in the primary windings of current sense transformer 84 is then

Imbalance=V*N₁/(F∥R_{L1})−V*N₂/R_{L2}, (5)

where N₁ is the number of turns around transformer 84 of split conductor 64 and N₂ is the number of turns around transformer 84 of split conductor 66.

Any existing alternating current appliance with constant load R_{L} could be retrofit to have leakage detection in the conductors of an attached power cord by choosing R_{L1}=R_{L}, and then adding a second, “split” conductor that terminates within the appliance in a resistance of value R_{L2}=N*R_{L} where N is some integer. Then, within the plug, the two split conductors would be wound around the differential sense transformer with a relative number of primary turns of N.

Returning to FIG. 3, it is noted that a broken or open circuited conductor in branch 64 would result in an imbalance in current. This is because a broken conductor could be modeled as an increase in line resistance Z₁ 86, causing most electrical current to take the lower impedance path through conductor 66 rather than through conductor 64. The broken conductor need not be completely open. For example, if some or most of the strands in a stranded conductor were broken or damaged, the resistance would also increase. This imbalance would be sensed as a fault condition in the differential transformer 84. A partially or fully broken conductor is a precursor to a series arcing fault. Accordingly, the split conductor design of the present invention can detect and interrupt a condition that could otherwise result in a series arc fault.

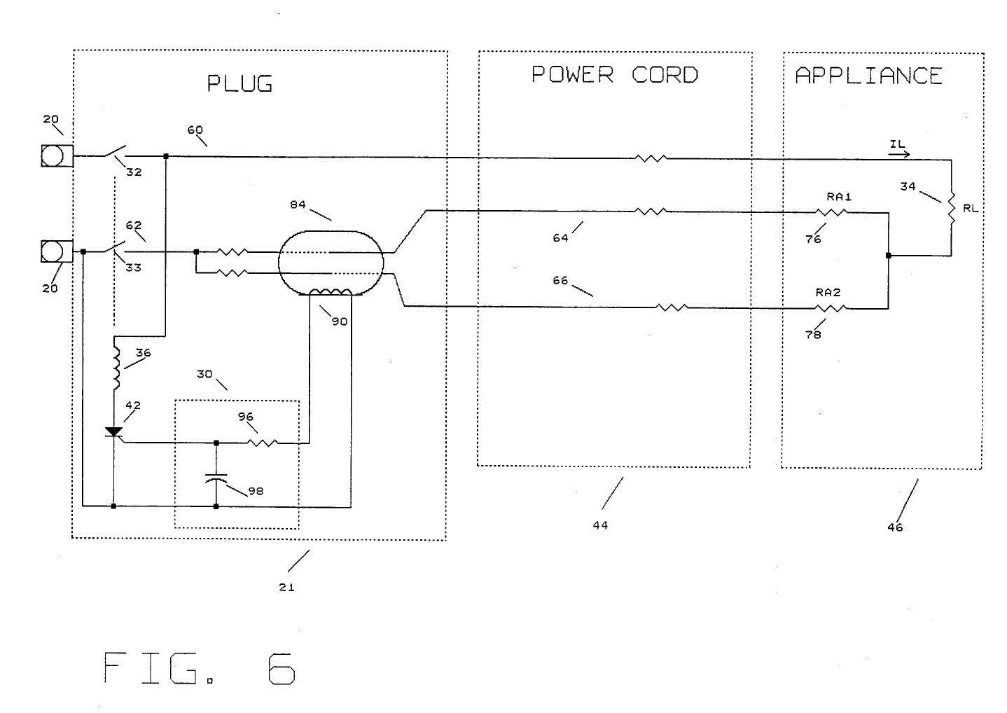

FIG. 6 depicts one specific embodiment for the split conductor approach for arc fault detection within the power cord. The plug 21 contains circuit breaker contacts 32 and 33 which serve to remove power from the power cord 44 and appliance 46 upon being triggered by the solenoid 36. Conductors 64 and 66 pass through the differential current sense transformer 84 in opposite directions so that any imbalance in these conductors induces a net magnetic flux in transformer 84. When there is a net magnetic flux in transformer 84, this induces a voltage in secondary winding 90. This induced voltage is filtered by trigger resistor 96 and filter capacitor 98, and, if of sufficient magnitude and duration, causes the firing of circuit breaker trigger thyristor 42. When thyristor 42 is fired, this energizes the solenoid 36, causing it to open the circuit breaker contacts 32 and 33, thereby removing power from the power cord and the appliance.

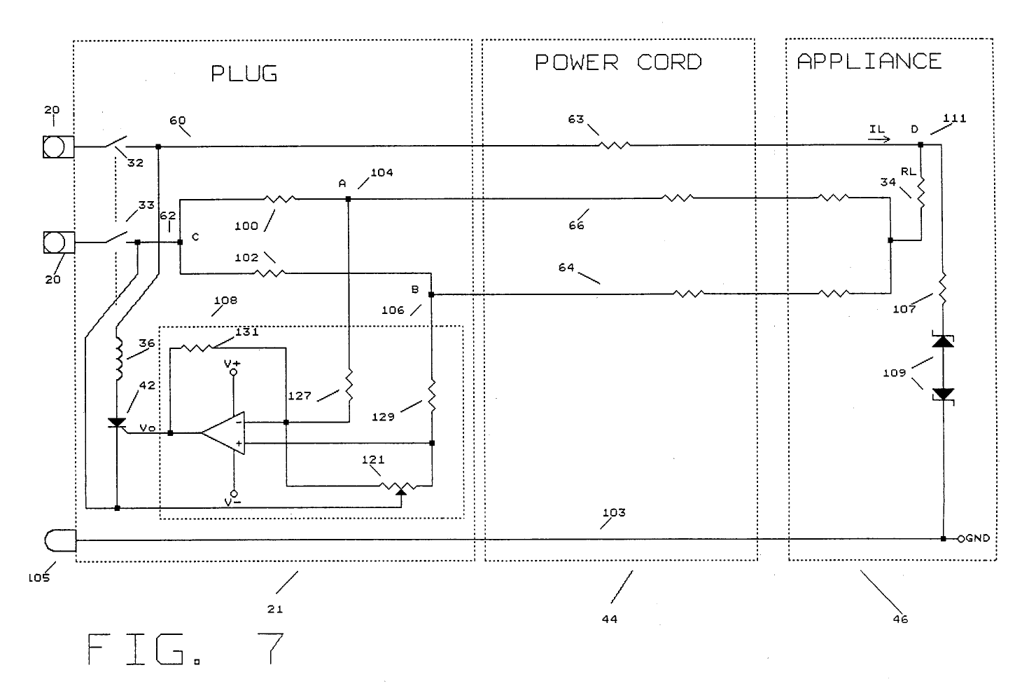

FIG. 7 depicts a second specific embodiment for the split conductor approach for arc fault detection. This embodiment does not require a current sense transformer for detecting the imbalances in the split conductors 64 and 66. Instead, the voltages across shunt resistors 100 and 102 are compared and the differential voltage is amplified and used to trigger the circuit breaker solenoid 36. If the current flowing through conductor 66 is the same as that flowing through conductor 64 (e.g., the currents are balanced) then the voltages generated at point A 104 and point B 106 (respectively VA and VB) will be the same and no circuit breaker triggering will occur. However, if there is an imbalance in currents, then this will be amplified by difference amplifier 108 with a gain that is proportional to the value of feedback resistor 131.

In practice there will be imbalances occurring among the various components of the system. As such, potentiometer 121 may need to be adjusted at the time of manufacture to “null out” the system so that in the absence of a fault, there is zero volts coming out of the amplifier 108.

If there is a significant difference between the two shunt voltages at nodes A 104 and B 106, then the output voltage V_{O} from the difference amplifier 108 will be sufficient to trigger the thyristor 42 causing the solenoid 36 to open the circuit breaker contacts 32 and 33.

The power cord 44 in FIG. 7 includes a so-called “ground wire” 103. Such ground wires are common in appliance cords and are connected at the plug 21 to a third prong 105 (which is inserted into the ground slot in a wall outlet) and are commonly connected to the chassis or housing of the appliance 46. The ground wire 103 is not designed to carry an electrical current except in the case of malfunction. As discussed earlier, the split conductor approach will detect the presence of a broken conductor (which would lead to a series arc fault) in one of the split conductors. This is because a broken conductor will result in a high resistance in one of the split conductors, causing a differential current when a load current is drawn. Now, all that is left for complete series arc fault detection within the power cord 44, is to be able to detect a broken conductor in the non split conductor 60.

In a system having a neutral or grounded conductor, the detection of all series arc faults within the power conductors may be accomplished by assigning the split conductors (64 and 66 in FIG. 7) to receive power from the hot (ungrounded) side of the source, while the nonsplit conductor 60 is connected to the neutral (grounded) side of the source. Then, in normal operation, because of its low value of resistance, there is very little voltage drop across resistor 63 and the voltage at point D 111 is approximately the same as the ground potential. There is thus no current flow in the ground wire 103. However, if a break in conductor 60 occurs, which would be equivalent to having an appreciable increase in resistance 63, then the voltage at point D 111 will rise an appreciable amount over the ground potential. Back to back zener diodes 109 serve to define a threshold voltage above which current will flow to ground. If the magnitude of the voltage at point D 111 exceeds the threshold voltage, then current will flow to the ground wire 103 through the zeners 109 and through limiting resistor 107 and will result in a ground fault which could be detected by a ground fault interrupt circuit (not shown). As a side benefit of this design, if the socket into which the plug is inserted has been miswired so that the hot (ungrounded) and neutral (grounded) sides of the source have been swapped, this will result in a current flow through resistor 107 to ground and will result in a ground fault, thereby tripping the circuit breaker and implementing miswiring detection.

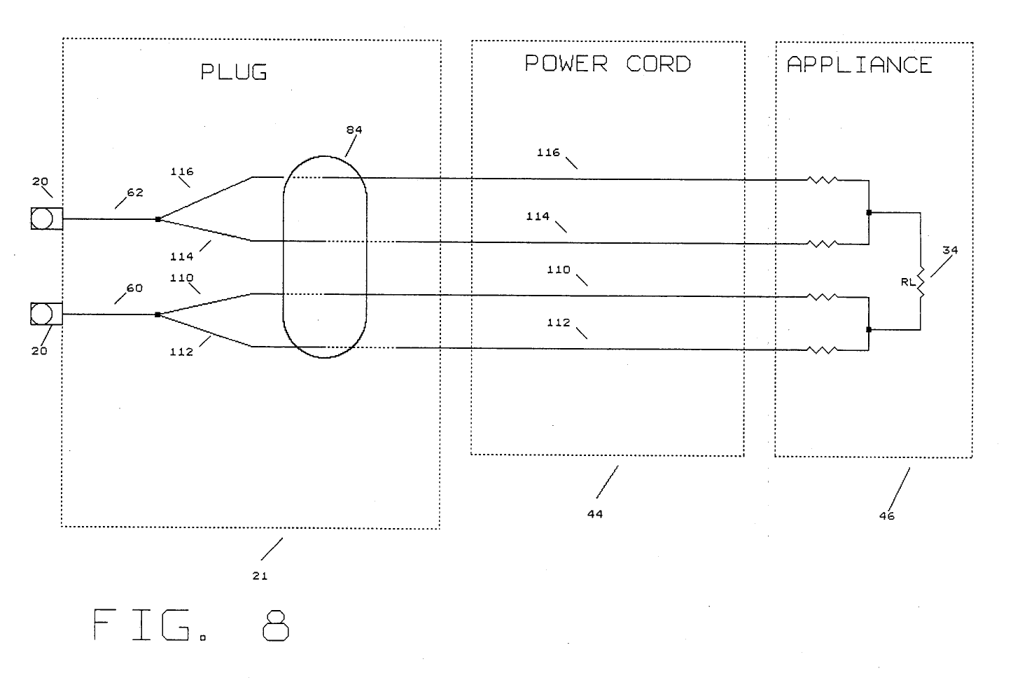

FIG. 8 depicts a design having both incoming conductors split into two parallel conductors within the power cord. This means that the power cord will have four conductors (five if a ground wire is added). From the plug prongs 20, conductor 60 divides into two split conductors 110 and 112. These split conductors 110 and 112 enter into the differential transformer 84 in opposite directions so that the fluxes generated by each of conductors 110 and 112 are opposing. Consequently, if there is an appreciable imbalance in the electrical current flowing in split conductors 110 and 112, it will result in a nonzero flux in the differential transformer 84 and, as before, can then generate a voltage in a secondary winding (not shown) which can then be amplified and filtered and used to trip a circuit breaker (not shown) and thereby remove power from the system. In a similar way, conductor 62 divides into split conductors 114 and 116, which pass through the differential transformer 84 in opposite directions and are rejoined within the appliance 46 to connect to the other side of the load 34. The advantage to this design is that any break in any conductor within the power cord 44 will manifest itself as a current imbalance and will thereby trip the circuit breaker. Accordingly, this design provides complete series arc fault protection within the power cord 44. The detection electronics and interruption means are not shown but operate identically to previously described systems. Although the four split conductors 110, 112, 114, and 116 are depicted as passing through the differential transformer 84 with one turn (that is, each conductor passes through the differential transformer 84 a single time), in practice, it might be advantageous to have varying number of primary turns, thereby ensuring that a fault from one split conductor to another would not cancel itself out in terms of the magnetic flux induced in the sense transformer 84.

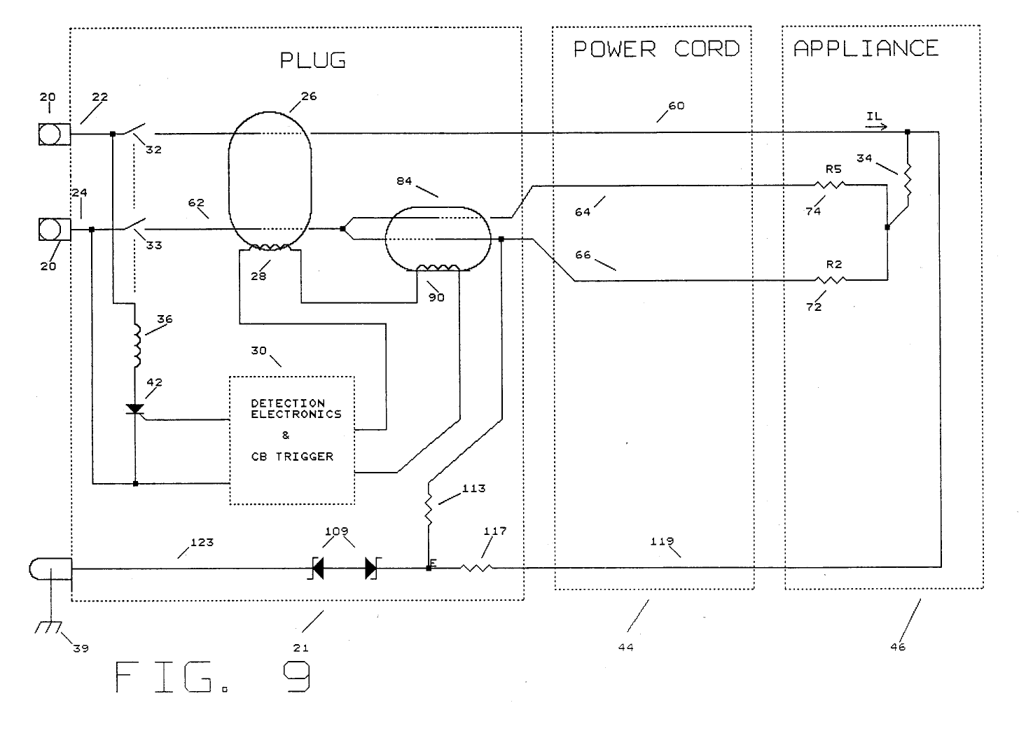

FIG. 9 depicts one embodiment of the arc fault detection of the present design as combined with a GFCI circuit. The GFCI serves to detect and protect against electrical leakage currents from any conductor to ground while the arc fault sensing circuit provides protection within the power cord 44 against electrical leakage currents flowing from one conductor to another (parallel arc faults) or from broken conductors within the split conductors (series arc faults). Accordingly, by combining the arc fault detection/interruption of the present invention with conventional GFCI detection/interruption, it is possible to achieve a high level of protection against adverse electrical events. In FIG. 9, incoming conductors 22 and 24 connect to circuit breaker contacts 32 and 33 respectively and then to conductors 60 and 62. Conductors 60 and 62 pass together in the same direction and orientation through the differential current sense transformer 26. Conductor 62 then divides into split conductors 64 and 66, which in turn are routed in opposite orientations through differential current sense transformer 84 and then pass out into the power cord and on to the appliance 46 where they are in series with appliance series resistors 74 and 72 and are then connected together at one side of the load 34. In this embodiment, the unsplit power conductor 60 runs directly through the power cord 44 to attach to the other side of the load 34.

The secondaries 28 and 90 of the two current sense transformers (26 and 84 respectively) are series connected so that an induced voltage in either may be sensed by the detection electronics/circuit breaker trigger 30. A ground fault of sufficient magnitude and duration will cause an appreciable voltage in the transformer secondary 28 and this will cause the firing of thyristor 42 and the consequent opening of circuit breaker contacts 32 and 33 thereby removing power from the power cord. In a similar way, an arc fault of sufficient magnitude and duration will develop an appreciable voltage in the transformer secondary 90 and this will cause the firing of thyristor 42 and the consequent opening of the circuit breaker contacts 32 and 33, thereby removing power from the power cord.

In FIG. 9, even though the differential transformers 26 and 84 are depicted as having a single turn on the primary winding (corresponding to the primary windings simply passing through the center of the transformer without looping), it may be advantageous to use multiple turns on the primaries of either or both of the differential transformers 26 and 84. With all other variables held constant, this allows for the variation of the sensitivity to respectively, a ground fault (using transformer 26) or an arc fault within the cord (using transformer 84). In a similar way, the number of windings in the transformer secondaries 28 and 90 can be adjusted to obtain the desired relative fault trip points, thereby allowing for a tuned sensitivity. The advantage to the design in FIG. 9 is that adding arc fault protection to GFCI protection in a power cord does not require much in the way of additional components or expense. The additions consist of a differential transformer 84, and a split conductor within the power cord 44.

FIG. 9 also depicts a configuration by which full series arc fault (broken wire) protection within the power cord 44 may be provided in an ungrounded electrical system. This is done by providing a return wire 119 which attaches to the unsplit conductor 60 at the load 34 and goes to the plug 21. Within the plug 21, a voltage divider is formed by using resistors 113 and 117 which meet at node E. When resistors 113 and 117 are chosen to have the same value of resistance, in the absence of a broken conductor, node E will maintain a potential that is very close to a ground potential. However, if conductor 60 is broken, then the potential at node E will have a potential that is different from a ground potential. If the magnitude of the potential at node E exceeds the threshold voltage of the back to back zener diodes 109, then a significant current will flow through conductor 123 to ground. This is recognized as a ground fault and serves to trigger the circuit breaker contacts, removing power from the power cord 44 and appliance 46.

It should be noted that FIG. 9 does not depict a ground wire going to the appliance. If such a ground wire is added, then the voltage divider resistors 113,117, and back to back zener diodes 109 can be optionally disposed within the appliance 46.

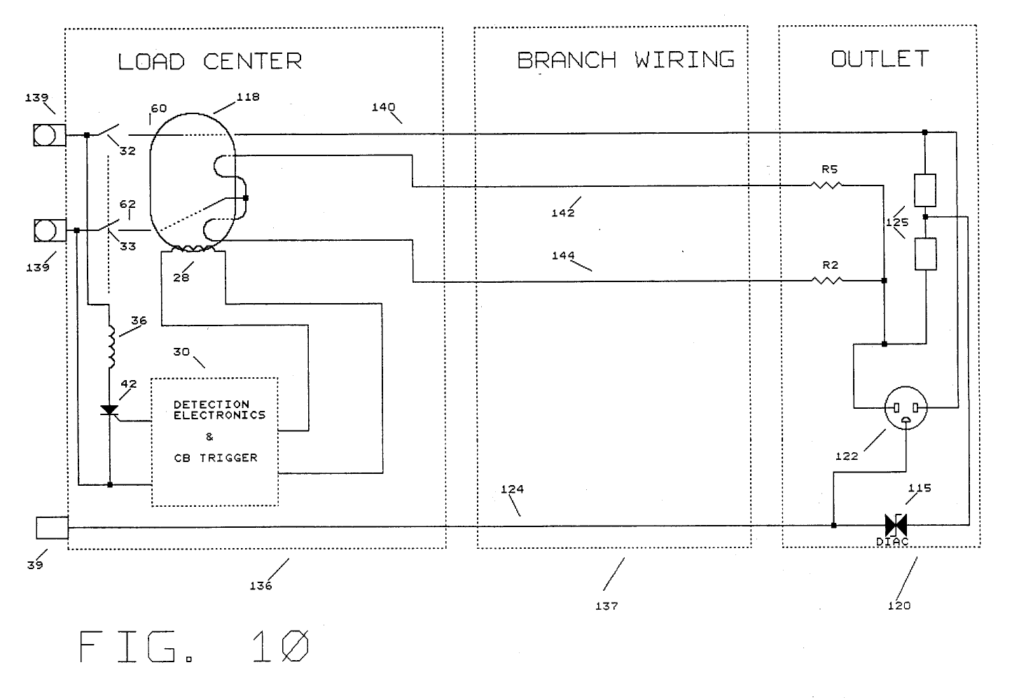

FIG. 10 depicts an application of the invention which is directed at a distribution system and which illustrates a couple of permutations of the basic design. This system represents an application to the wiring in a residential or commercial building whereby the branch wiring 137 connecting a load center 136 and an electrical outlet 120 is protected against arcing faults. In this embodiment, arc fault detection is combined with a conventional GFCI circuit. In this design, the same differential transformer 118 is used for both arc fault detection as well as ground fault sensing. By adjusting the primary winding turns ratios, a relative sensitivity between ground fault sensing and arc fault sensing can be controlled. The advantage of the design is that it requires no more electronic circuitry over a conventional GFCI with the only added cost being a multiconductor branch wiring that allows parallel (split) conductive paths. In order to adjust the relative sensitivities of the two classes of faults, the relative number of primary turns might be adjusted. For example, in order to have a higher sensitivity for ground fault sensing, relative to arc fault sensing, the incoming conductors 60 and 62 might be wound around the sense transformer multiple times. Instead of an appliance load, FIG. 10 depicts a female receptacle 122. Although only one female receptacle 122 is shown, multiple female receptacles could be added in parallel with no loss of generality. In FIG. 10, the load would be one or more external electrical devices, each having a plug, and each attached to the female receptacle 122. The depiction in FIG. 10 can represent a system whereby both source conductors are ungrounded. In such a system, the ground potential will be located approximately midway between the two input voltages. In order to provide series arc fault detection/interruption in conductor 140, a voltage divider 125 has been added across the load. This voltage divider 125 can be made up of relatively high value, matched resistances. If 220 volts appears across the line (equivalently, across power inputs 139), then a reasonable choice for the resistances in voltage divider 125 might be 10 Kohm at 2 watts each. Alternatively, at 60 Hz, a voltage divider using 0.22 μF capacitors could be used without causing excessive power dissipation. With balanced components, the center of the voltage divider 125 should maintain a potential that is approximately equal to the ground potential. However, if a broken conductor occurs in conductor 140, then the potential drop across that break will impact the center point of the voltage divider 125, causing it to shift. If the amount of the voltage shift away from ground is sufficient to surpass the trigger point of a bilateral trigger diode (diac) 115, then it causes the discharge of current into ground and causes the ground fault interrupt to sense a fault and to open the circuit breaker contacts 32,33.

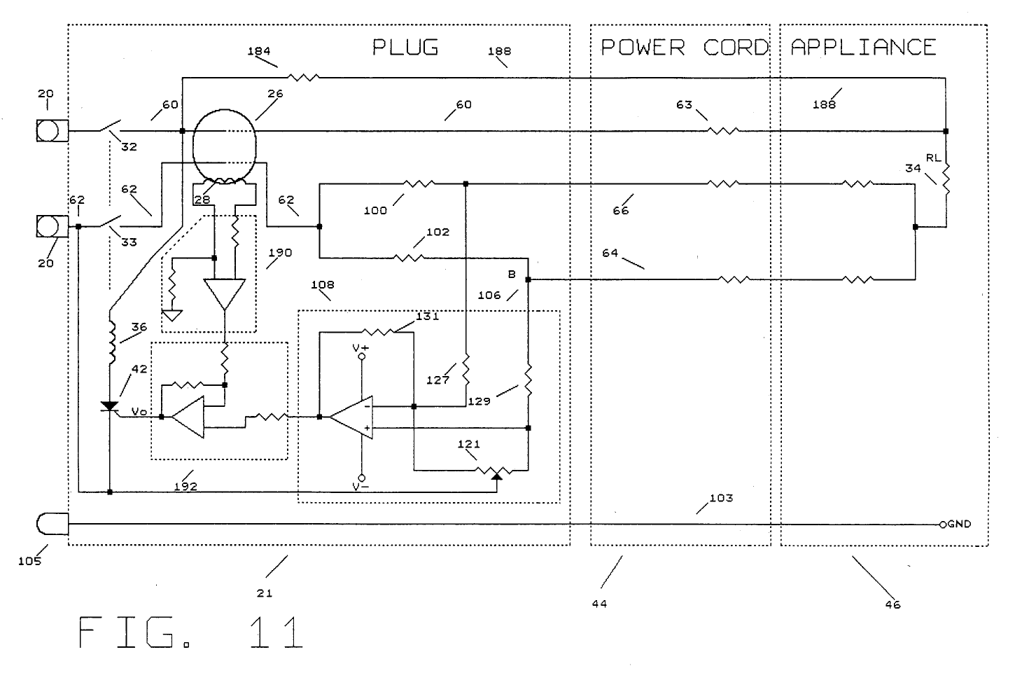

FIG. 11 depicts a specific embodiment of the cordset of the present invention, which offers complete series and parallel arc fault protection for an appliance cordset. Conductors 61 and 62 pass through sense transformer 26 in the same orientation and in unfaulted operation carry virtually all of the current to the load. Any substantive imbalance in the current flow in these two conductors is sensed by the transformer secondary 28 and is amplified by amplifier 190. Conductor 62 is split into two parallel conductors 64 and 66. When there is no break in conductors 64,66 or no leakage within the cord from either of conductors 64 or 66, then the current flow in these two conductors is approximately equal. When the current flows are equal, the voltages across shunt resistances 100 and 102 will be the same and amplifier 108 will have approximately zero output. The outputs of amplifiers 190 and 108 are combined by amplifier 192. So, if a fault is detected and amplified by either amplifier 190 or amplifier 108, it will have the effect of a nonzero signal Vo at the output of amplifier 192. This will trigger thyristor 42, energizing the solenoid 36 and causing the breakers 32 and 33 to open. It should be noted that amplifier 192 as depicted in FIG. 11 is often referred to as a summing amplifier and is readily constructed using electronic devices such as operational amplifiers and/or transistors.

In order to detect a broken wire in the unsplit conductor 60, a return wire 188 is used to connect between the plug 21 and the load 46. Resistor 184 serves to limit the current flow through return wire 188 so return wire 188 may be of very light gauge and in normal operation carries very little current. Return wire 188 is electrically in parallel with conductor 61. If conductor 61 is unbroken, then by far the majority of current flow from the plug to the load will run through conductor 61. For example, if conductor 61 is six feet long and made of 14 gauge wire, then it will have a nominal resistance of 0.015 ohms. If resistor 184 is chosen to be 1000 ohms, then by current divider law, in normal operation, conductor 188 would carry less than 0.002% of the current in conductor 61 and of the load current in the appliance. On the other hand, if conductor 61 is completely or substantially severed, then its resistance goes up, causing more current to flow in conductor 188. This current bypasses sense transformer 26, so there is a current imbalance. That is, current enters the sense transformer through conductor 62 and returns entirely (or in part) through conductor 188. This causes a voltage to be induced across the secondary 28, and the circuit breaker contacts 32,33 are tripped. Accordingly, having the return wire 188 enables the detection of a broken conductor (series arc fault) in conductor 61. Note that even in normal operation, in the absence of a fault, some small amount of current will still flow in conductor 188, however, this current flow is so small that negligible imbalance occurs at the sense transformer 26. Although the above description has assumed that the return wire 188 did not pass through the sense transformer 26, sensitivity can be enhanced by passing it through in an opposite sense from conductor 61. By using multiple turns, sensitivity may be further enhanced to a broken or damaged conductor 61. If the return conductor 188 is severed, it will never result in a series arc fault because resistor 184 will limit the current flow. The circuit in FIG. 11 provides complete series and parallel arc fault protection within the cord regardless of the type of electrical system. No assumption of a grounded neutral is necessary. Although a ground wire 103 is shown, it is not necessary for the correct functioning of the circuit.

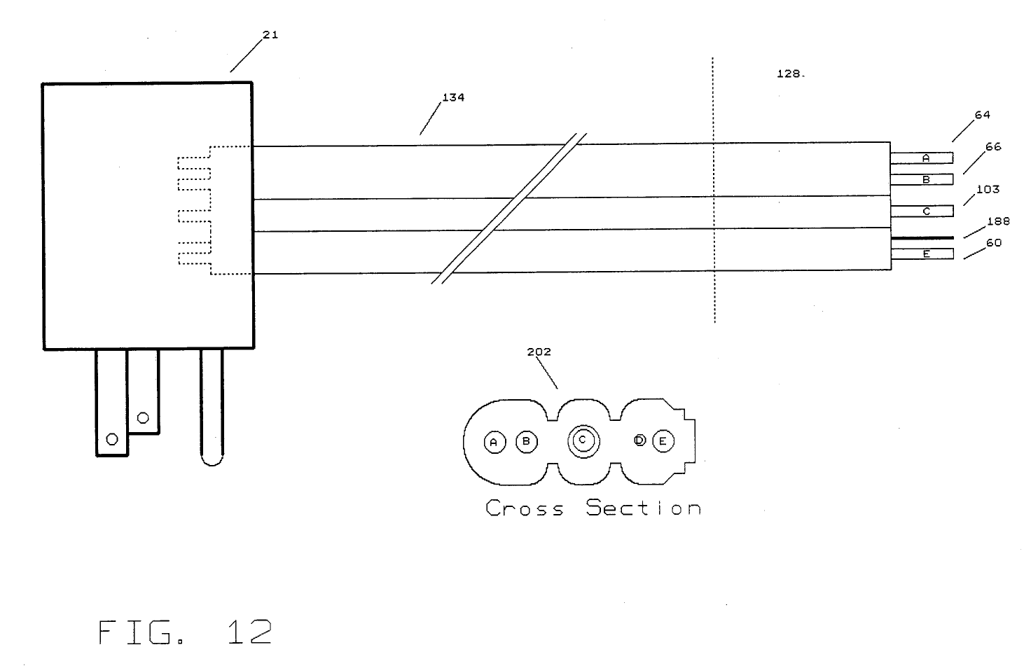

FIG. 12 depicts one possible construction configuration for an electrical appliance power cord. This would correspond, for example, to the implementation described in conjunction with FIG. 11. All fault sense electronics are resident in the plug 21. The power cord 134 is a five conductor flat SPT style power cord. It has split conductors 64 and 66, which in normal operation will have the same voltage potential relative to ground. Conductor 103 is the ground conductor. Conductor 61 is a non-split conductor that carries most of the load current that is delivered to the load by split conductors 64 and 66. The return line 188 would generally be a relatively small diameter wire and is used for sensing a broken conductor 61. The split conductors 64 and 66 could be constructed using the same wire gauge in order to ensure an approximately equal conductor resistance, or might be chosen to have different gauges, with the unbalanced design being compensated for by adding higher resistance components in series with the low resistance conductor, or by using more turns on the current sense transformer on the high resistance side of the split conductors. In order to ensure the presence of sufficient and balanced appliance series resistance, which is necessary for the correct functioning of the proposed invention, a certain length of the power cord would be designated for securing within the appliance. This “nonexposed” length (the region 128 to the right of the dashed line in FIG. 12) might nominally be chosen to be 10% of the power cord length. For example, if the power cord was sixty inches in length, the nonexposed length might be six inches in length. At the load side of the cord, conductors 64 and 66 would be connected and conductors 61 and 188 would be connected. Then as far as the user is concerned, the cordset 134 functions like, and may be wired to, an appliance exactly as a three wire cordset would be wired. The cordset of FIG. 12 would serve to provide ground fault and arc fault protection within the cord if attached to any appliance. However, when connected to an appliance, care would have to be made to ensure that the nonexposed length of cord in region 128 was preserved (not shortened) and was secured within the appliance in such a way that it would not flex or be exposed to conditions which could cause insulation breakdown. Alternatively, the cord could be provided with five exposed leads for attachment by an appliance manufacturer without regard to maintaining an unexposed length of cord. However, in this case, the manufacturer would need to provide for series resistances within the appliance prior to connecting the split conductors together and then to the load.

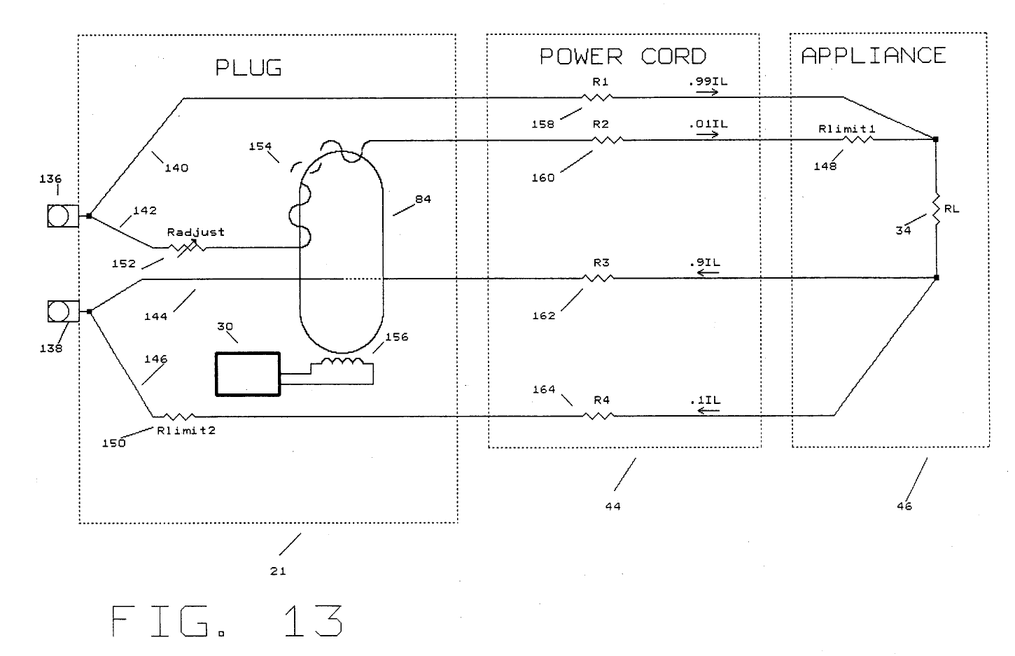

FIG. 13 depicts an additional specific embodiment for fault sensing using the split conductor method of the present invention. In this embodiment, each of the two power carrying conductors at the plug 21 is split into two parts, one with a relatively high resistance and one with a relatively low resistance, to comprise a total of four power carrying conductors that connect the plug 21 to the appliance 46. In some applications, a fifth wire for ground might also connect between plug 21 and appliance 46 but no such ground wire is depicted in FIG. 13 and a ground wire is not required for the correct function of the circuit as described herein.

Since all wire has an associated distributed resistance, there is some nonzero resistance associated with any arbitrary segment of any conductor in FIG. 13. This resistance is represented by lumped resistances 158,160,162 and 164. Although depicted in FIG. 13 as being located within the power cord, these resistances are, in fact, distributed throughout each conductor, and in particular, are partially located within the appliance.

In FIG. 13 the power is supplied to the plug 21 via two power connections 136 and 138. The power from connection 136 is furnished to the load 34 via two split conductors 140 and 142. The power from connection 138 is furnished to the load 34 via two split conductors 144 and 146. Conductors 140 and 144 have a relatively low resistance and supply the bulk of the power to the load 34. Conductors 142 and 146 have a relatively high resistance. Conductors 142 and 144 act as the primary windings for sense transformer 84. The limit resistors 148 and 150 serve to ensure the split of current so that conductors 140 and 144 carry the bulk of the current. The adjustment resistor 152 is used to balance the circuit. This balancing might be at the time of manufacture, or, resistor 152 might be dynamically adjusted during operation in order to preserve a balance condition. The role of the balance resistor 152 is to ensure that the circuit is balanced in the absence of a fault so that the net flux developed in the sense transformer 84 is zero and the net voltage developed on the transformer secondary 156 is zero.

Conductor 142 is looped around the sense transformer 84 some number of primary turns N. Resistors 148,150 and 152 are chosen so that the ampere turns due to the primary winding 154 of conductor 142 equals the ampere turns in the primary winding due to conductor 144. This represents a balanced condition.

The secondary 156 of the current sense transformer 84 serves to detect flux in the transformer that is generated due to a fault condition. The voltage developed across this secondary 156 is amplified and/or filtered by the detection electronics and circuit breaker trigger module 30 and used to fire a circuit breaker (not shown) which interrupts current flow in the power cord.

As a specific example of how the system of FIG. 13 might be configured. Assume that the resistances in the system are chosen so that

Radjust+R2+Rlimit1=99*R1

and

R4+Rlimit2=9*R3.

Then by the well known current divider law, the current in conductor 144 will be ninety percent of the current through the load and the current in conductor 142 will be one percent of the current through the load and the ratio between these two currents will be ninety. Accordingly, the primary turns (depicted in FIG. 13 as 154) on conductor 142 should be ninety times as many as the primary turns on conductor 144. Within the power cord 44, if a fault resistance develops to ground or between any two conductors and develops a significant current flow, this will result in an imbalance that will cause a net flux in the current transformer 84 and that will, in turn, cause a voltage on the secondary 156 of the transformer which can be amplified and/or filtered and used to trigger a circuit breaker, thereby removing power from the system.

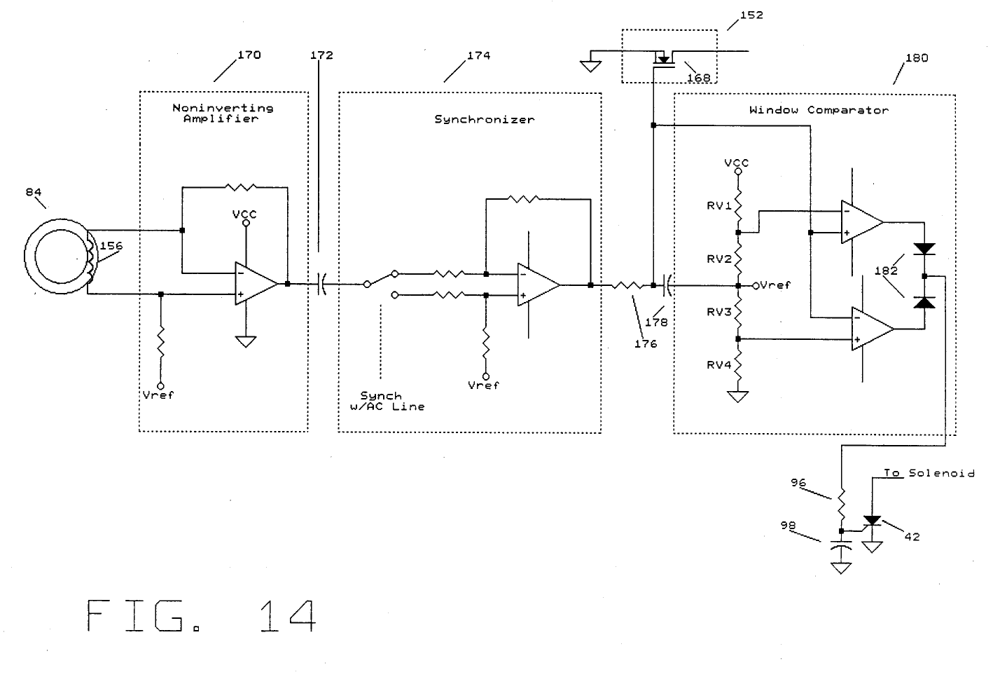

FIG. 14 depicts a specific embodiment for a circuit that could be used to dynamically tune the system of FIG. 13. A variable resistance 152 consists of a gate controlled MOSFET 168. The drain to source resistance of MOSFET 168 varies according to the gate excitation. A DC power supply voltage, Vcc, is assumed to be available. This can be easily generated from the AC power source. MOSFET 168 is biased to have a nominal voltage of Vref. This voltage is half of Vcc and is derived using a voltage divider consisting of resistors RV1, RV2, RV3 and RV4. A transformer 84 is used to sense current imbalances in the conductors (the conductors are not shown in FIG. 14). The secondary 156 of transformer 84 develops a voltage whenever an imbalance condition is sensed. The output voltage from the secondary 156 will be an AC waveform with the same fundamental frequency as the input from the source, generally 50 to 60 Hertz. This signal is fed to a noninverting amplifier 170 and is amplified. The output of the amplifier then feeds into a capacitor 172 which removes any DC components. The resulting AC waveform is fed to a synchronizer 174 which performs synchronous rectification to generate an output signal which will be either in-phase with the AC line (if the variable resistance 152 needs to be reduced) or out-of-phase with the AC line (if the variable resistance 152 needs to be increased). Charge storage capacitor 178 maintains the gate excitation for MOSFET 168. Charging resistor 176 is used to control the rate of charge/discharge of capacitor 178. A window comparator 180 compares the gate voltage on the MOSFET 168 with a high and low benchmark defined by the voltage dividers RV1-RV4. If the gate voltage is out of range either high or low, this serves to trigger thyristor 42, thereby energizing a solenoid (not shown) and causing a circuit breaker (not shown) to open. In effect, the circuit of FIG. 14 is a detail of a possible implementation of the detection electronics and circuit breaker trigger (30 in FIG. 13) and of the adjustment resistor (152 in FIG. 13).

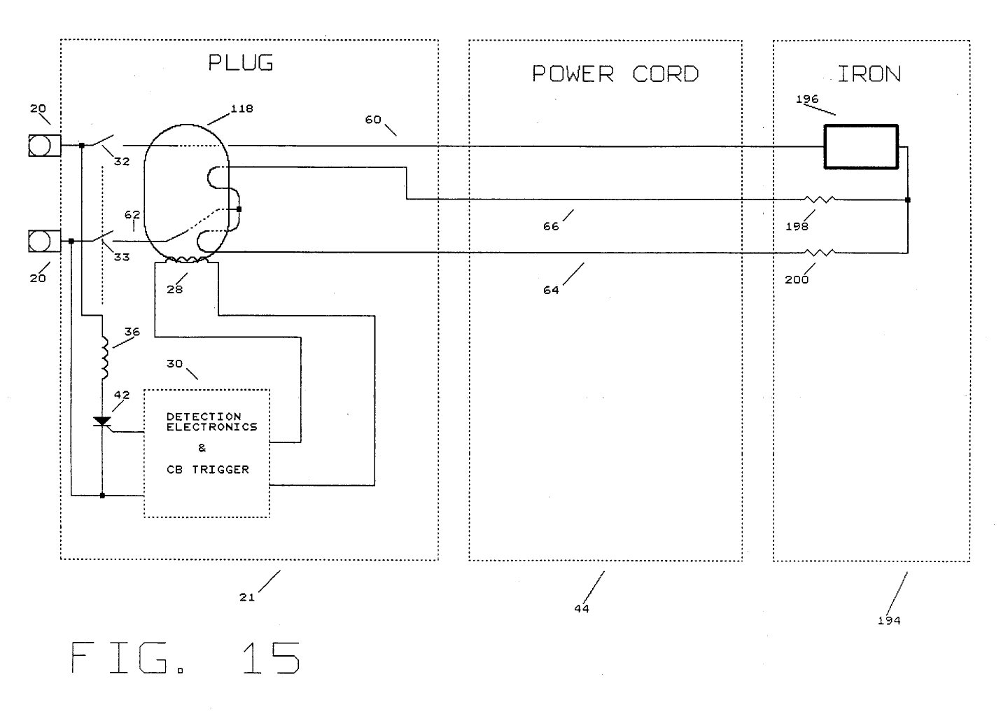

FIG. 15 depicts a specific embodiment that is directed at an electric iron. Electric irons and certain power tools are unique in that during use, the power cord may undergo continuous flexing. This can result in repetitive stresses that can break wires internal to the iron, leading to arcing across the conductors in the cordset and resulting in electrical fires. Other electrical loads such as heaters, curling irons or hair dryers, may be dangerous because when their heat is accidentally applied to the power cord, it may cause a breakdown in the cord insulation. The circuit in FIG. 15 is built to be a minimal implementation. The electrical configuration in the plug 21 is almost identical to that of a two wire ground fault interrupt. Power enters the plug through two prongs 20. These go to circuit breaker contacts 32,33 and connect to conductors 60, 62. The conductors 60,62 pass together through a current sense transformer 118 with the same orientation. If the conductors 60,62 simply passed directly through to the appliance (in this case an electric iron 194) through a two wire cord, then the plug 21 would represent an appliance leakage current interrupt type of device commonly found on hair dryers in the U.S. This is a relatively low cost device that is presently being built in the tens of millions. However, by splitting conductor 62 into two conductors, 64,66 and then passing each of the splits through the sense coil with the same number of turns but in opposite directions, it is possible to obtain arc fault protection in addition to ground fault protection. Now, there are three wires connecting between plug 21 and iron 194. Two of these share the load current. The third is a return. The heater load is evenly split between load elements 198 and 200. Elements 198,200 play a multiple role. First they ensure a balance in the current flow between conductors 64,66 during unfaulted operation. Second, they serve as the appliance resistance that is necessary for fault detection, so it is unnecessary to enforce a requirement for a length of power cord to be held captive within the iron 194. In FIG. 15, controller 196 represents any electrical controls that might be used in the iron. These might include thermostats, thermal fuses, switches or electronic controls.

The implementation depicted in FIG. 15 would detect and interrupt an electrical leakage from any of conductors 64,66 or 60 to ground. The implementation depicted in FIG. 15 would detect and interrupt an electrical leakage from either of the loads 198,200 to ground. The implementation depicted in FIG. 15 would detect and interrupt an electrical leakage from either of conductor 64 or 66 to conductor 60 (a parallel arc fault). The implementation depicted in FIG. 15 would detect and interrupt a broken conductor in either of conductors 64 or 66.

Although the above discussion pertaining to an electric iron assumed that loads 198 and 200 are balanced, it may be easily inferred that the loads 198,200 may be different, so long as within the sense transformer 118, the net ampere turns from each of the split conductors 64 and 66 balance. For example, if load element 198 is 20 ohms and load element 200 is 10 ohms, then conductor 66 must loop twice as many times around sense transformer 118 as does conductor 64 because conductor 66 will carry only half as much current as conductor 64. Although the above discussion centers upon the case of an electric iron, the design may be extended to any arbitrary electrical load which can be split into two parts.

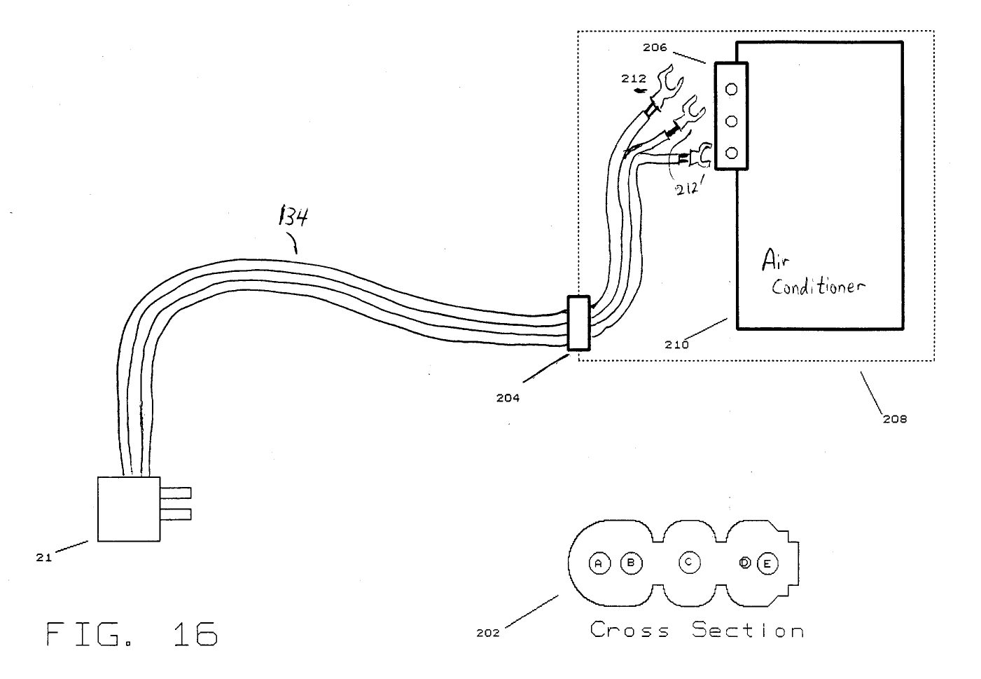

FIG. 16 depicts the present invention as applied to cordset electrical leakage protection for a room air conditioner. The cord 134 is of the style described in conjunction with FIG. 12. It has five conductors, imbedded in insulation in such a way that externally it appears much like a conventional three wire flat power cord. This is seen from the cross-section 202, where it may be seen that while there are five conductors internally, these are arranged as a group of two, a single wire and a group of two. The plug receptacle 21 houses the electronics that implements the electrical leakage detection and interruption of the present invention. Internal to the plug 21, conductors A and B are electrically connected and these two conductors serve as parallel paths, with a common voltage potential, to supply power in one direction to the air conditioner load 210. Conductor E supplies power in a return direction from the air conditioner load 210 and conductor C is normally at a ground potential and does not normally carry power. Conductor D is a sense lead that is used to detect a broken or damaged conductor E.

The air conditioner housing 208 is the sheet metal covering that surrounds much of the air conditioner compressor, fan, controls and ducting. This sheet metal covering is generally electrically connected to the ground conductor in the power cord 134. The power cord 134 enters into the air conditioner housing 208 at a grommet 204. The grommet 204 provides a means to prevent the power cord 134 from being abraded or cut by the air conditioner housing 208. This grommet 204 might further serve as a mechanical means of securing the power cord 134 so that it is not pulled loose from the air conditioner unit. In some embodiments, rather than a grommet 204, there might be a chamfered entry hole. Inside the air conditioner housing 208 is a terminal block 206 which serves as a means to electrically connect the power cord to the air conditioner electrical load. Between the grommet 204 and the terminal block 206 is a length of cord that serves to ensure some resistance in each of the parallel power delivery paths, thereby enabling fault detection at all points in the power cord between the plug 21 and the air conditioner housing 208.

The five conductors in power cord 134 may be brought together into three spade lug connections 212. Conductors A and B would be electrically connected and then attached to one spade lug. Conductors D and E would be electrically connected and then attached to a second spade lug. The center conductor, C, would serve as the ground conductor and would be electrically connected to a third spade lug. Because there are only three terminations, as far as a user is concerned, the power cordset depicted in FIG. 16 would have a plug 21 connecting to a power cord 134 that, from all appearances, looks like a conventional three wire power cord, having two power carrying conductors and a ground. This cord would be attached to the terminal block 206 in the exact same way that a conventional three wire power cord would be attached. For example, in a grounded neutral system, one spade lug would be labeled for connection to neutral, one would be labeled for connection to hot and the third would be designated as ground. The spade lugs might be placed under screws in the terminal block 206. In some embodiments, the terminal block 206 might only accommodate two connections with the ground connection going directly to the air conditioner housing 208.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An apparatus for detection and interruption of electrical leakages in an electrical distribution system, said apparatus comprising:
multiple conductors wherein at least two of said multiple conductors serve as parallel paths for delivering power to an attached electrical load;
a circuit breaker;
means for detecting current imbalance between said parallel paths; and
means for activating said circuit breaker in response to detection of said current imbalance between said parallel paths, thereby preventing power delivery to said attached electrical load.

2. The apparatus of claim 1 wherein said parallel paths maintain substantially a same voltage potential.

3. The apparatus of claim 1 wherein said parallel paths are connected together on one side of said attached load.

4. The apparatus of claim 1 wherein said electrical load is an electrical appliance.

5. The apparatus of claim 4 wherein a portion of said multiple conductors is secured within said electrical appliance to ensure a minimum level of resistance in each of said parallel paths.

6. The apparatus of claim 1 wherein said circuit breaker, said means for detecting current imbalance and said means for activating said circuit breaker are disposed within a plug receptacle.

7. The apparatus of claim 6 wherein said parallel paths are electrically connected together within said plug receptacle.

8. The apparatus of claim 6 further comprising means for detecting an imbalance in current flow coming from two power delivery prongs of said plug receptacle by use of a current sense transformer.

9. The apparatus of claim 8 further comprising an electronic amplifier to trigger said circuit breaker in response to either a sensed current imbalance in said parallel paths or a sensed current imbalance from currents flowing in said power delivery prongs, said electronic amplifier containing a device selected from the group consisting of thyristors, transistors and operational amplifiers.

10. The apparatus of claim 1 wherein said means for detecting current imbalance comprises means for sensing a secondary voltage of a differential current transformer.

11. The apparatus of claim 10 wherein said current imbalance is equivalent to an ampere turn imbalance in said differential current transformer.

12. The apparatus of claim 1 wherein said means for detecting current imbalance comprises means for comparing voltages across shunts that are in electrical series with said parallel paths.

13. The apparatus of claim 1 wherein said means for detecting current imbalance comprises means for sensing a change from a predetermined current division between said parallel paths.

14. An apparatus for detection and interruption of electrical leakages, said apparatus comprising a power cord with three power carrying conductors connecting a plug receptacle to an appliance load, and further comprising:
means for detecting an unbalanced current flowing within two of said three power carrying conductors; and
means to interrupt current flow upon detection of said unbalanced current.

15. The apparatus of claim 14 wherein said two of three power carrying conductors are electrically connected to each other at said plug receptacle, thereby forcing them to maintain a substantially equivalent voltage potential.

16. The apparatus of claim 15 wherein said appliance load is divided into two parts, each of which is connected to one of said two of three power carrying conductors.

17. The apparatus of claim 15 wherein said appliance load is an electric iron or an electric heater.

18. The apparatus of claim 14 wherein said means to detect an unbalanced current flow comprises a current sense transformer or means for comparing voltages across current shunts.

19. The apparatus of claim 14 further comprising a fourth conductor for attachment to earth ground and which does not normally carry power.

20. The apparatus of claim 19 further comprising means for ground fault detection and interruption.

21. The apparatus of claim 20 wherein when a voltage between the third of said three power carrying conductors and said fourth conductor exceeds a threshold amount, it results in current flow in said fourth conductor, thereby activating ground fault detection and interruption and thereby preventing series arcing in said third conductor due to a break in said third conductor.

22. The apparatus of claim 14 wherein within said plug receptacle said two of said three power carrying conductors pass through a current sense transformer in opposite directions and then are electrically connected to a plug prongs that attaches to said plug receptacle.

23. An apparatus for detection and interruption of electrical leakages comprising a power cord with four distinct conductors connecting a plug receptacle to an appliance load, and wherein:
first and second of said four conductors have a same voltage potential and serve to carry substantially all power from said plug receptacle to said appliance load in one direction;
third and fourth of said four conductors have a same voltage potential and carry substantially all power from said plug receptacle to said appliance load in a return direction; and
additionally comprising means for detecting an electrical current imbalance in said first and second conductors and for tripping a circuit breaker in response thereto.

24. The apparatus of claim 23 wherein said means for detecting an electrical current imbalance comprises means for detecting a change from a predetermined current division between said first and second conductors.

25. The apparatus of claim 23 additionally comprising means for detecting an electrical current imbalance in said third and fourth conductors and means for tripping a circuit breaker in response thereto.

26. The apparatus of claim 25 wherein said means for detecting an electrical current imbalance comprises means for detecting a change from a predetermined current division between said third and fourth conductors.

27. The apparatus of claim 23 wherein said third conductor carries substantially all power from said plug receptacle to said appliance load in an opposite direction from said first and second conductors and said fourth conductor serves as a means for sensing damage in said third conductor.

28. The apparatus of claim 27 wherein said damage is sensed upon presence of a voltage potential on said fourth conductor that is different from a voltage potential of said third conductor by a value that is in excess of a predetermined voltage potential, and wherein a circuit breaker is activated in response thereto, thereby serving to interrupt power delivery in case of a break in said third conductor and thereby preventing occurrence of a series arc fault in said third conductor.

29. The apparatus of claim 28 wherein said predetermined amount of voltage potential is electronically monitored using one or more devices selected from the group consisting of diodes, zener diodes and bilateral trigger diodes.

30. The apparatus of claim 23 additionally comprising a fifth conductor for attachment to earth ground and which does not normally carry power.

31. The apparatus of claim 23 wherein said appliance load comprises a room air conditioner.

32. The apparatus of claim 1 wherein said attached electrical load comprises a room air conditioner.

33. A method for detection and interruption of electrical leakages in an electrical distribution system, the method comprising the steps of:
attaching to an electrical load multiple conductors wherein at least two of the multiple conductors serve as parallel paths for delivering power to the electrical load;
detecting current imbalance between the parallel paths; and
activating a circuit breaker in response to detection of a current imbalance between the parallel paths, thereby preventing power delivery to the electrical load.

34. A method for detection and interruption of electrical leakages, the method comprising the steps of:
connecting between an appliance load and a plug receptacle a power cord with three power carrying conductors;
detecting an unbalanced current flowing within two of the three power carrying conductors; and
interrupting current flow upon detection of an unbalanced current.

35. A method for detection and interruption of electrical leakages, the method comprising the steps of:
connecting between an appliance load and a plug receptacle a power cord with four distinct conductors, wherein first and second of the four conductors have a same voltage potential and serve to carry substantially all power from the plug receptacle to the appliance load in one direction, and wherein third and fourth of the four conductors have a same voltage potential and carry substantially all power from the plug receptacle to the appliance load in a return direction; and
detecting an electrical current imbalance in the first and second conductors and tripping a circuit breaker in response thereto.
